(19) United States
(12) Patent Application Publication
(10) Pub. No.: US 2026/0141044 A1
(43) Pub. Date: May 21, 2026

(54) METHOD AND SYSTEM FOR AUTHENTICATION BASED ON UNEXPECTED STIMULI

(71) Applicants: AT&T Intellectual Property I, L.P., Atlanta, GA (US); AT&T Technical Services Company, Inc., Vienna, VA (US)

(72) Inventors: Joseph Soryal, Glendale, NY (US); Michael Gonzales, Austin, TX (US); Yupeng Jia, South Pasadena, CA (US); Adrianne Binh Luu, Atlanta, GA (US); Robert Moton, JR., Alpharetta, GA (US); Daniel Vivanco, Ashburn, VA (US); Robert Koch, Norcross, GA (US); Ari Craine, Marietta, GA (US)

(73) Assignees: AT&T Intellectual Property I, L.P., Atlanta, GA (US); AT&T Technical Services Company, Inc., Vienna, VA (US)

(21) Appl. No.: 18/955,310

(22) Filed: Nov. 21, 2024

(51) Int. Cl. G06F 21/32; G06V 40/18

(52) U.S. Cl. CPC G06F 21/32; G06V 40/18

(57) ABSTRACT

Aspects of the subject disclosure may include, for example, receiving, over a network, a captured reaction of a user experiencing a stimulus, where the stimulus is presented during accessing of an application by the user at an end user device; analyzing the captured reaction by a comparison with a baseline reaction of the user that is previously obtained; and providing an authentication over the network to the end user device in response to the comparison. Other embodiments are disclosed.

### FIELD OF THE DISCLOSURE

The subject disclosure relates to a method and system for authentication based on unexpected stimuli.

### BACKGROUND

In the realm of digital security, techniques for verifying the identity of users accessing various systems and applications can be important. Traditional methods primarily rely on single-factor authentication, such as passwords or PINs. While these methods are straightforward, they are increasingly vulnerable to security breaches due to weak or easily guessable passwords, phishing attacks, and other forms of cyber threats.

To enhance security, additional verification factors have been introduced, requiring users to provide more than one form of verification. While this can improve security, this approach also introduces new challenges and complexities. One of the primary difficulties with current techniques is the user experience. The process of providing multiple verification factors can be cumbersome and time-consuming, leading to user frustration and potential resistance to adopting these security measures. Additionally, the reliance on physical devices, such as smartphones or security tokens, can be problematic if these devices are lost, stolen, or unavailable.

Another challenge is the static nature of current systems. Techniques often require the same level of verification regardless of the context or risk level of the transaction. This can result in either overburdening the user with unnecessary steps for low-risk activities or under-securing high-risk activities by not adapting to the specific context.

Furthermore, methods that rely on physical or static characteristics, while offering a higher level of security, are not foolproof. Data can be spoofed or falsified, and there are concerns about the privacy and security of storing such sensitive information. Additionally, the accuracy of these systems can be affected by various factors, such as changes in the user's appearance or environmental conditions.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of another system functioning within the communication network of FIG. 1 in accordance with various aspects described herein.

FIG. 2C depicts an illustrative embodiment of a method in accordance with various aspects described herein.

FIG. 2D is a block diagram illustrating an example, non-limiting embodiment of another system functioning within the communication network of FIG. 1 in accordance with various aspects described herein.

FIG. 2E depicts an illustrative embodiment of a method in accordance with various aspects described herein.

FIG. 2F is a block diagram illustrating an example, non-limiting embodiment of another system functioning within the communication network of FIG. 1 in accordance with various aspects described herein.

FIG. 2G is a block diagram illustrating an example, non-limiting embodiment of another system functioning within the communication network of FIG. 1 in accordance with various aspects described herein.

FIG. 2H is a block diagram illustrating an example, non-limiting embodiment of another system functioning within the communication network of FIG. 1 in accordance with various aspects described herein.

FIG. 2I depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for authenticating a user's identity without requiring the user to be disrupted, without requiring interaction with an end user device (e.g., no requirement to enter a password such as in a multi-actor authentication technique) and/or without knowledge by the user of the authentication procedure taking place. The system and methodology can present (or otherwise identify) one or more unexpected stimuli that the user experiences, can collect data describing the user's response or reaction to the unexpected stimulus, and can authenticate the identity of the user if the response is as expected for the user (e.g., based on stored baseline reactions and/or predicted reactions).

In one or more embodiments, the system and methodology can provide identity authentication in such a manner that it is transparent or non-disruptive to the user. In one or more embodiments, the system and methodology can provide procedures that combat hackers who use techniques such as artificial intelligence to spoof a user's identity.

In one or more embodiments, the system and methodology leverages unexpected stimuli to verify user identity in a seamless and non-intrusive manner. In one or more embodiments, the system and methodology can provide authentication based on unexpected stimuli which are presented to the user during their interaction with an application whereby the user's response (e.g., reaction) to these stimuli is captured and analyzed to authenticate their identity. This approach is unique as it does not require explicit user interaction for authentication, making the process more seamless and less disruptive.

In one or more embodiments, the system and methodology can provide dynamic adjustment of authentication complexity. For example, the system can dynamically adjust the complexity and/or a confidence or accuracy threshold of an authentication, including based on high-risk access and low-risk access.

In one or more embodiments, the system and methodology can provide for integration or cooperation of multiple devices and/or sensors. For example, the system can leverage onboard and/or external sensors to gather comprehensive biometric and environmental data including user reactions. As another example, the system can leverage onboard and/or external components or devices and functionality to present or provide one or more stimuli to the user, including a stimulus provided (or identified) with a video being shown or a stimulus external to the video (e.g., a flashing light, an emitted sound, etc.). This data including user reactions can be used to enhance the accuracy and reliability of the authentication process. In one embodiment, external cameras or microphones can be used in conjunction with the device's onboard sensors to capture biometric information and user responses to stimuli.

In one or more embodiments, the system and methodology can provide real-time and context-aware authentication. For example, the system can continuously or frequently update the user's location and other contextual information, allowing for real-time adjustments to the authentication process. This ensures that the authentication requirements are always aligned with the current context and potential security threats.

In one or more embodiments, the system and methodology can provide for the use of Artificial Intelligence (AI). For example, the system can employ AI models to analyze the authentication information and other associated data to make various determinations including characteristics of stimuli, predicted reactions, accuracy thresholds, predicted gaze, detected reaction confidence level, and so forth. This AI-driven analysis allows for more accurate and adaptive authentication decisions.

In one or more embodiments, the system and methodology can provide for temporary authentication and access control. For example, temporary authentication can be provided which enables users to access applications for a limited time period based on an initial authentication which can be followed up by a subsequent authentication, which can be more robust in some embodiments. This feature is particularly useful for scenarios where continuous authentication is not feasible or necessary. In other embodiments, initial access to an application can be granted and the authentication can occur at some time during the communication session (e.g., during the video streaming).

In one or more embodiments, the system and methodology can provide for comprehensive data management. For example, the system can maintain a detailed database of various data including user information and device information. For example, the data can include biometric IDs, device IDs, device locations, passwords, and/or sensor data. This database can be used to verify identities and manage the authentication process, ensuring that all relevant data is considered in the authentication decision.

Overall, the system and methodology provides a more secure, flexible, and context-aware approach to authentication, addressing the limitations of existing systems and enhancing protection against potential security threats including through the use of unexpected stimuli for authentication, dynamic adjustment of authentication complexity, and/or integration of multiple devices and/or sensors.

In one or more embodiments, the components and/or functionality described herein can be used in conjunction with, in place of, and/or replaced by one or more components and/or functionality described in U.S. Application Ser. No. ______ filed on ______, 2024, entitled “Method and System for Multi-Factor Authentication” having docket number 2023-0488_7785-3600A, the disclosure of which is hereby incorporated by reference in its entirety. As an example, the authentication functions described herein including use of one or more unexpected stimuli can be utilized in conjunction with a dynamic authentication process. In one embodiment, the type of authentication can be determined based on a confidence level with respect to a previous authentication including a capturing of a user image. One or more of the exemplary embodiments, can make use of or otherwise perform integration of biometric identification, environmental sensors, and/or AI-driven analysis to determine stimuli to be used for obtaining user attention, user conditions, authorization levels, and/or types of temporary relationships, such as physical access by remotely unlocking a door or communication access by establishing a voice or video call between users.

In one or more embodiments, the system and methodology provides a dynamic authentication system and methodology which can be multi-factor and/or which can adjust a complexity of a second or subsequent authentication factor and/or adjusts a completeness or accuracy required based on a confidence level of a first or previous authentication determination, thereby offering a more robust and adaptable solution to current authentication difficulties. In one or more embodiments, the complexity of the authentication request(s) can be selected based on various factors, including a type of application being accessed (e.g., video streaming with a low complexity MFA vs banking with a high complexity MFA).

In one or more embodiments, the system and methodology provides an improved multi-factor (e.g., two or more) authentication method to allow users to authenticate using both a first factor biometric authentication, and a second factor biometric, or non-biometric authentication. For example, the second factor authentication level of complexity can be dependent upon a confidence level of the user passing the first factor biometric authentication.

In one or more embodiments, the system and methodology provides a multi-factor authentication, which dynamically adjusts the complexity of the second authentication factor based on the confidence level of the first authentication factor. This method can enhance security by varying the degree of authentication required, depending on the initial confidence level, thereby providing a more robust and adaptable authentication process.

In one or more embodiments, the system and methodology provides for dynamic adjustment of second (or additional) factor authentication. For example, a system can be provided in which the complexity of the second authentication factor is dependent on the confidence level of the first authentication factor. For instance, if the first factor biometric authentication yields a high confidence level, the second factor may require only partial input, such as 50% of a password. Conversely, if the confidence level is lower, the system may require a more complete or different form of second authentication.

In one or more embodiments, the system and methodology provides for integration of multiple sensors. The system can leverage both onboard and external sensors to gather comprehensive biometric and environmental data. This data can be used to enhance the accuracy and reliability of the authentication process. For example, external cameras or microphones can be used in conjunction with the device's onboard sensors to capture biometric information, background data, and so forth.

In one or more embodiments, the system and methodology provides real-time and context-aware authentication. For example, the system can continuously update the user's location and other contextual information, allowing for real-time adjustments to the authentication process. This ensures that the authentication requirements are always aligned with the current context and potential security threats.

In one or more embodiments, the system and methodology provides for employing AI models to analyze the first authentication information and other associated data to determine the confidence level. This AI-driven analysis allows for more accurate and adaptive authentication decisions. In one or more embodiments, the complexity of the authentication request(s) can be selected based on various factors that are analyzed via AI modeling, including the type of application being accessed and an assessed risk of hacking or fraud such as based on an identity of the user (e.g., the user has had his or her identity stolen in the past).

In one or more embodiments, the system and methodology provides a more secure, flexible, and context-aware approach to multi-factor authentication, addressing the limitations of existing systems and enhancing protection against potential security threats.

In one or more embodiments, the system and methodology describes a first authentication and a second authentication in a multi-factor authentication process. However, it should be understood that any number of authentications can be utilized including three, four or more. In one embodiment, the number of authentication and/or adding an additional authentication step can be based on a confidence level and/or completeness threshold for the first authentication, second authentication or any one or combinations of preceding authentication steps that have occurred.

In one or more embodiments, the components and/or functionality described herein can be used in conjunction with, in place of, and/or replaced by one or more components and/or functionality described in U.S. application Ser. No. 18/921,806 filed on Oct. 21, 2024, the disclosure of which is hereby incorporated by reference in its entirety. As an example, the authentication functions described herein including use of an unexpected stimuli, use of a completeness threshold and/or use of a confidence level can be utilized in conjunction with the temporary relationships established for physical and/or communication access between users.

One or more aspects of the subject disclosure include a method comprising receiving, by a processing system including a processor over a network, an authentication request associated with a user accessing an application of an end user device. The method can include providing, by the processing system over the network, stimulus information, where the providing of the stimulus information causes a stimulus to be presented to the user independent of user interaction with the end user device, where the stimulus is presented during the accessing of the application by the user. The method can include receiving, by the processing system over the network, a captured reaction of the user experiencing the stimulus. The method can include analyzing, by the processing system, the captured reaction by a comparison with a baseline reaction of the user. The method can include providing, by the processing system, an authentication in response to the comparison satisfying a reaction threshold.

One or more aspects of the subject disclosure include a device, comprising a processing system including a processor; and a memory that stores executable instructions that, when executed by the processing system, facilitate performance of operations. The operations can include receiving, over a network, a captured reaction of a user experiencing a stimulus, wherein the stimulus is presented during accessing of an application by the user at an end user device; analyzing the captured reaction by a comparison with a baseline reaction of the user that is previously obtained; and providing an authentication over the network to the end user device in response to the comparison.

One or more aspects of the subject disclosure include a non-transitory machine-readable medium, comprising executable instructions that, when executed by a processing system including a processor of an end user device, facilitate performance of operations. The operations can include providing a user with access to an application being executed via the end user device; providing, over a network, an authentication request associated with the access by the user; and receiving, over the network, an authentication in response to a comparison satisfying a reaction threshold, where the comparison is performed by a processing system, where the comparison is of a captured reaction of the user experiencing a stimulus with a baseline reaction of the user, where the stimulus is presented to the user independent of user interaction with the end user device, and where the stimulus is presented during accessing of the application by the user.

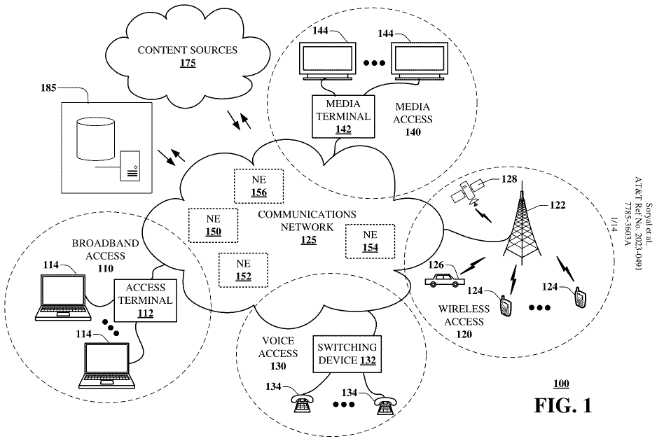

Referring now to FIG. 1, a block diagram is shown illustrating an example, non-limiting embodiment of a system 100 in accordance with various aspects described herein. System 100 can include a platform 185 that can perform a number of functions for authenticating and/or managing temporary relationships (including physical access and/or communication access) between users based on specific conditions, such as proximity, user condition, and/or user authorization level. Platform 185 can include various components and functionality to implement the authenticating and/or temporary relationship management including in a centralized fashion through one or more servers (e.g., located in the network core or elsewhere), in a distributed fashion (e.g., operating in one or more edge servers), in a virtualized fashion (e.g., operating via virtual machines or virtual functions such as in the Cloud), and/or in a combination of these fashions.

For example, platform 185 can facilitate in whole or in part receiving, over a network, a captured reaction of a user experiencing a stimulus, where the stimulus is presented during accessing of an application by the user at an end user device; analyzing the captured reaction by a comparison with a baseline reaction of the user that is previously obtained; and providing an authentication over the network to the end user device in response to the comparison.

Platform 185 can operate as an authentication server to overcome the difficulty that a user often is required to be authenticated as to their identity for proper use and access of an application, while enabling a transparent and seamless authentication to be performed. Moreover, platform 185 provides techniques that can combat hackers using techniques such as artificial intelligence to spoof a user's identity.

System 100 provides that a user may be equipped with a wireless device, such as a smart phone or wearable device. The device may be equipped with a user authentication app that is in communication with a user authentication server that has access to an authentication database. The user device may be equipped with various on-board sensors, such as a camera, microphone, various biometric sensors, motion, sensors, a gyroscope, and others. There may also exist one or more external sensors, such as an external camera, that exist within a location that is proximate to the location of the user or user device. In one embodiment, the wireless device (or other end user device) can be part of a vehicle, such as a vehicle communication or entertainment system.

In one embodiment, one or more external sensors or stimulus device may register or be registered in an authentication database with a record specific to the sensor or device. This record may include a unique sensor/device ID, and electronic address for the sensor/device, a location for the sensor/device, and/or a range of operational area across which the sensor/device may operate.

In one embodiment, the user may register in a user ID record in the authentication database using the user authentication app. This registration allows the user authentication app to respond to authentication requests when received and use the data in the user record to validate such authentication requests. In one embodiment, the user record includes a unique user ID, a device address for the user, and a location for the user device, which may be continually or frequently updated using the location aware capabilities of the user device.

In one embodiment, the user may equip their device with an application, such as a video content app that is in communication with a video content server, to provide, for example, paid video content. Any number of other types of applications may be applicable, however, the video content app is used here as an exemplary embodiment.

For this embodiment, the user authentication server may insert a visual stimulus into the video stream or may cause the visual stimulus to be presented as an overlay on video frames. This visual stimulus may be a subtle, but noticeable visual insertion, such that it is sufficient to catch the eye of the user. The stimulus may be inserted at a time that the app is presenting content that might not otherwise catch the user's eye so that the stimulus is more likely to be noticeable and result in a response by the user. For this example of a visual stimulus, the user may react by glancing at the stimulus which can include eye movement and/or head movement.

In one embodiment, the user's reaction time may be included in stimulus response/reaction data, along with tracking data of how their eyes react to the stimulus using data collected from a camera on the device. A change in the user's pupil dilation or a response to the stimulus by changes in the user's facial properties, such as a facial reaction or squinting, may also be recorded as stimulus response/reaction data. For example, the user may also utter a response using a spoken word or other sound. This may also be represented in stimulus response/reaction data. In these examples, data is captured or created to describe the stimulus and/or the user's response/reaction to it in the record of the database.

Other types of unexpected stimuli may be presented to the user, using their own user device and/or by using other stimuli producing devices that are located in the vicinity of the user device. For example, an external speaker or an external light source may be used to produce a stimulus, if they are known to be located in the area of the user. Data regarding these external stimulus producing devices may be stored including their ID and range of operation. In this example, for instance, an external camera may be used to record the user's reactions, which may include body movement as sensed by a motion detector, change in gait, or other visually detected responses, or audibly detected responses by the user to the unexpected stimulus.

In one embodiment, a user authentication app may receive a request from another app on the user device (or on another device) to authenticate the user's identity. In response, a user authentication server may access data from the authentication database to determine one or more types of stimuli response data that has been stored and/or predicted for the user, which can be mapped to particular stimuli.

In one embodiment, the user authentication server may use its knowledge of the sensors and other devices in the location proximity of the user that are capable of creating a stimulus, so as to understand what type of unexpected stimulus may be created to approximate how the user has responded to a similar unexpected stimulus in the past. As a result, the user authentication server may use the stored stimuli data, and send it to one or more stimulus producing devices, which may include the user device, to produce the unexpected stimulus, and present it to the user, resulting in a user identity authentication challenge.

In one embodiment, the type of application being accessed (which can include particular characteristics of the functionality) can dictate or otherwise be utilized for selecting or determining a type of stimuli and/or characteristics of the stimuli. For example, a banking application would necessitate a more accurate authentication to prevent fraud so the stimuli can be selected accordingly such as a particular stimuli which is predicted or known to cause a particular reaction that can be more accurately identified. In contrast, video streaming may only warrant a lower level of authentication so selecting a stimulus (such as a brief blinking light in a dark night sky in video content) which can result in less accurate matching for a user reaction (e.g., the user is known to have a number of different reactions to a blinking light rather than known to have a single distinct reaction each time) may be suitable.

In one embodiment, the authentication server may collect data from the onboard sensors and/or external sensors that describes the user's response or reaction to the unexpected stimulus and may compare the reaction (which can be considered challenge data results) with stored stimuli response or reaction information for the user. A determination can be made as to whether the user identity is confirmed based on a match, such as within an accuracy or confidence threshold.

In one embodiment, one or more biometric sensors, for example, on the user device, may be used in conjunction with a biometric application on the user device to determine if the user's biometric state is in normal limits. If not, for example, where the user's biometrics predict the user to be sleepy, the threshold for a match of the comparison of the user's response to expected response data may be adjusted in terms of the threshold. For example, the user's response time may be expected to be slower if the user is sleepy. Moreover, if the user is asleep or otherwise impaired from being normally responsive, another means of authentication would be used (or other action taken). Other biometric feedback for the user can be utilized for managing the authentication process including adjusting accuracy thresholds to be applied to a comparison of a captured user reaction to a baseline user reaction.

In one embodiment, the activities and/or content being watched can play a role in adjusting the threshold (e.g., an action movie may not generate a strong stimulus response if a flashing light is inserted into the video frames as the stimulus).

In another embodiment, the stimulus may not need to be created explicitly, but, rather, for instance, in the example of authenticating a user to watch video content, based on the user's previous viewing of video content, the authentication server may make a prediction for a likely manner in which the user will watch the current content. For example, the user may more frequently watch a specific favorite actor. Each user, over time, may develop typical habits for how they consume media visually based on their eye movements over time. In this case, the user's consumption of the content may be continuously or frequently monitored throughout the presentation of the content so that the user is not only authenticated once to access the content, but may be authenticated continuously or frequently throughout their consumption of the content.

As another example, platform 185 can facilitate in whole or in part obtaining, over a network, first authentication information associated with a user; analyzing the first authentication information to determine a first authentication and to determine a confidence level for the first authentication; selecting a type of second authentication information from among a group of different authentication queries for a second authentication; providing a request for the second authentication information to an end user device associated with the user; receiving the second authentication information from the end user device; and authenticating the user according to the second authentication information based on a completeness threshold, where at least one of the selecting of the type of second authentication information or the completeness threshold is based on the confidence level.

As another example, platform 185 can facilitate in whole or in part determining a first location of a first user and a second location of a second user; determining that the first user and the second user are within a threshold distance according to the first and second locations; determining an authorization level of the second user; determining to establish a temporary relationship between the first and second users according to a condition of the first user and according to the authorization level of the second user; and facilitating establishing of the temporary relationship between the first user and the second user by enabling at least one of physical access to the first user, communication access for a second end user device of the second user to a first end user device of the first user, or a combination thereof.

In one or more of the examples described herein, users are frequently described as first, second, third, etc, which should be understood as distinguishing between users in the particular example but is not intended to be limiting in any other way unless expressly described as such.

In one or more embodiments, platform 185 can enable physical access to a first user by remotely unlocking a lock or door to a premises where the first user is located. In one or more embodiments, platform 185 can enable communication access to the first user by establishing (e.g., automatically without requiring user initiation) one of a voice or video communication session between first and second end user devices.

In one or more embodiments, platform 185 can determine a condition of the first user based on user data collected from sensors. In one or more embodiments, the user data can include an image of the first user, and the sensors are part of a device that is distinct from the first end user device. In one or more embodiments, the user data comprises biometric information of the first user, and the sensors are part of the first end user device. In one or more embodiments, platform 185 can determine a mitigation action has occurred with respect to the condition of the first user; and can facilitate removing of the temporary relationship between the first user and the second user by disabling the at least one of the physical access or the communication access. In one or more embodiments, platform 185 can: determine a third location of a third user; determine that the first user and the third user are within another threshold distance according to the first and third locations; determine another authorization level of the third user; determine to establish another temporary relationship between the second and third users according to the condition of the first user and according to the other authorization level of the third user; and facilitate establishing of the other temporary relationship between the second user and the third user by enabling communication access for a third end user device of the third user to the second end user device of the second user.

In one or more embodiments, platform 185 can receive user information from sensors that are positioned in a premises of the first user; and can receive biometric information of the first user, where the determining to establish the temporary relationship between the first and second users is based on applying an Artificial Intelligence (AI) modeling to the user information and the biometric information.

In one or more embodiments, platform 185 can: determine a mitigation action has occurred with respect to the condition of the first user; evaluate a result of the mitigation action; and adjust the authorization level of the second user according to the evaluating.

In particular, a communications network 125 is presented for providing broadband access 110 to a plurality of data terminals 114 via access terminal 112, wireless access 120 to a plurality of mobile devices 124 and vehicle 126 via base station or access point 122, (and/or via satellite 128), voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices. In various embodiments, the satellite 128 can be configured for bi-directional communication with one or more access points, with one or more base stations, and/or with one or more mobile devices (e.g., direct-to-cell). In various embodiments, the satellite 128 can comprise a Low Earth Orbit (LEO) satellite or a Geostationary Orbit (GEO) satellite.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VOIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

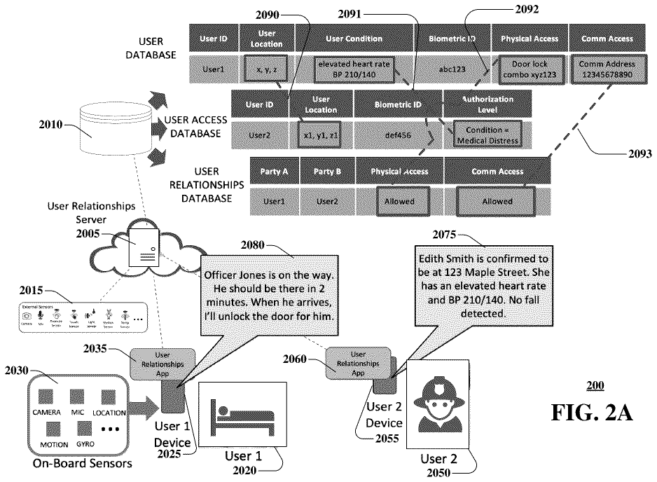

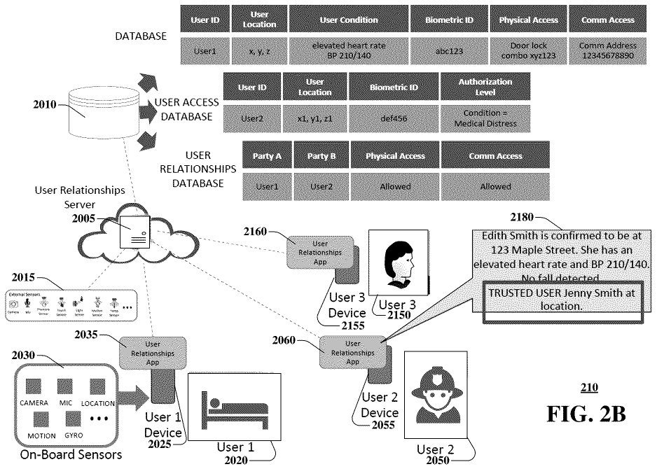

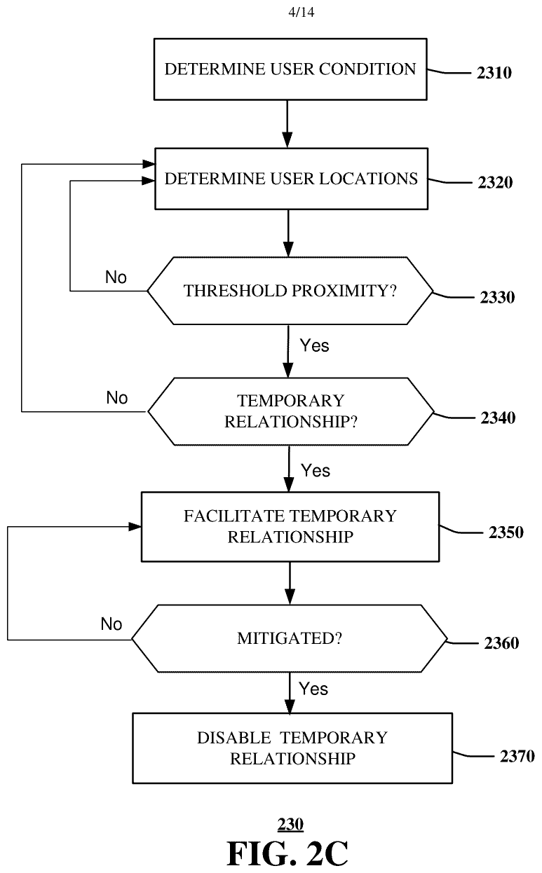

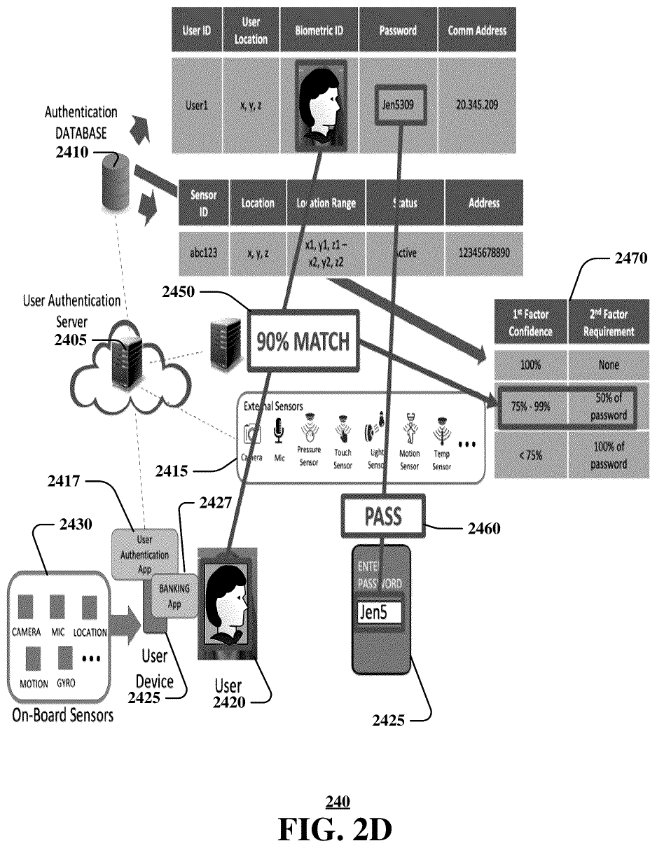

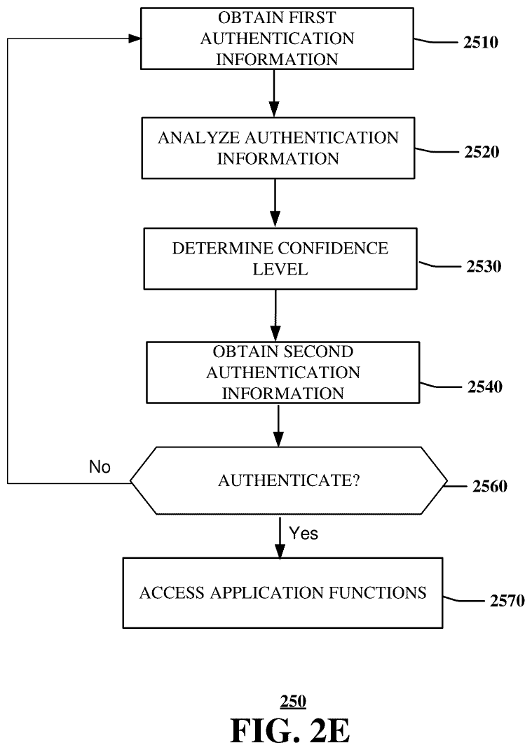

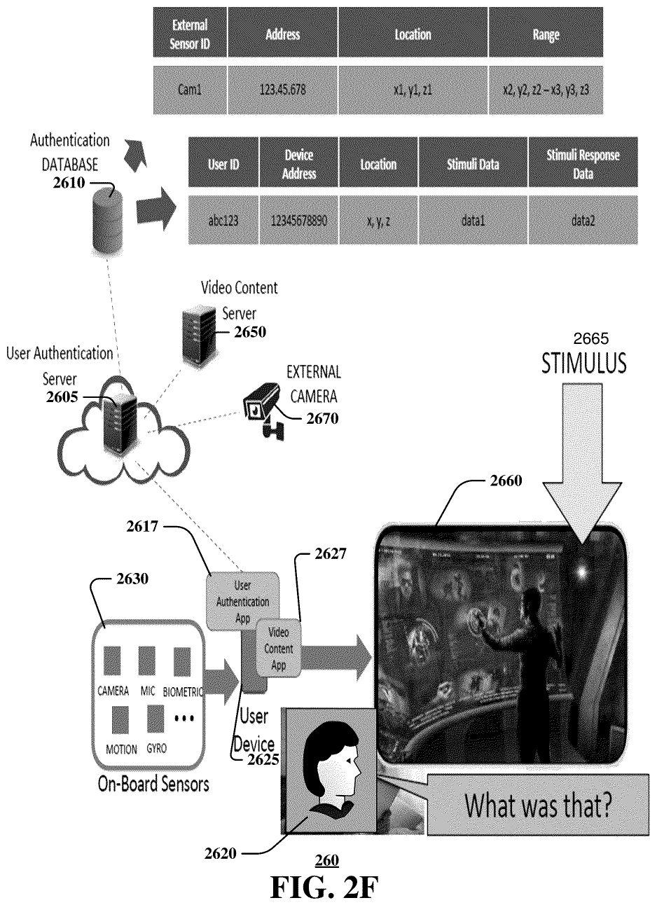

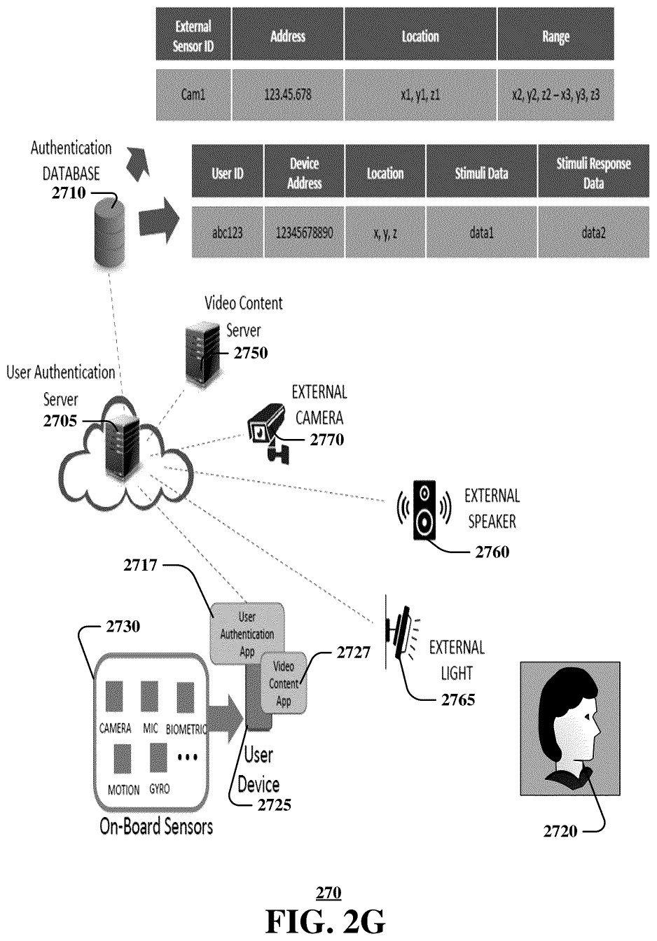

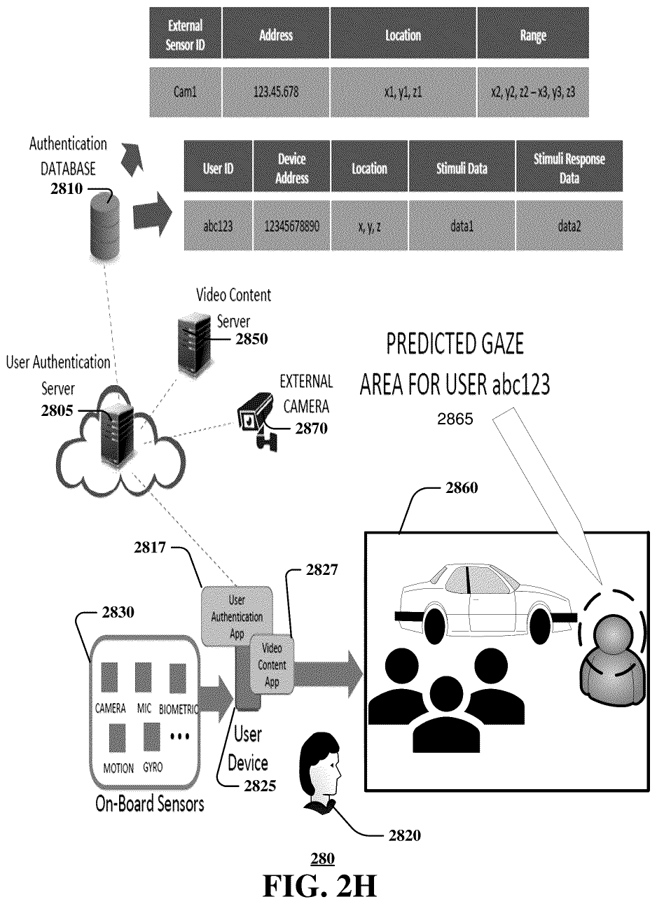

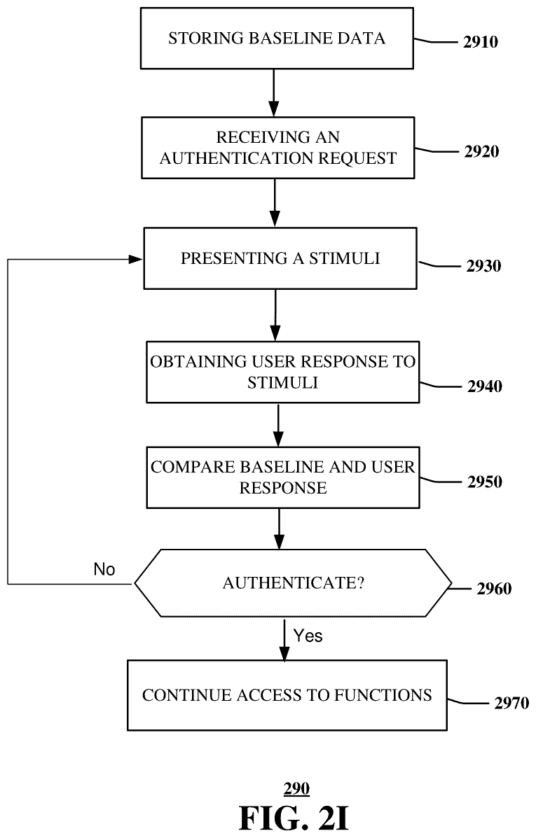

FIG. 2A is a block diagram illustrating an example, non-limiting embodiment of a system 200 functioning within the communication network of FIG. 1 in accordance with various aspects described herein. System 200 can manage and/or establish temporary relationships between users based on specific conditions. The system 200 includes any number of users but illustrated is a first user 2020 having a first end user device (UE) 2025 and a second user 2050 having a second UE 2055.

The system 210 can include hardware and/or software (which can include virtual functionality) for providing temporary relationship management, such as a user relationship server 2005 and a user information database 2010. As an example, the database 2010 can be a single database or multiple databases. The database 2010 can operate as a user database storing user information including but not limited to user ID data, user location data, user condition data, biometric ID data, physical access data, and/or communication access data. The database 2010 can operate as a user access database storing other user information (e.g., associated with other users that may be granted a temporary relationship with a first user) including but not limited to other user ID data, other user location data, other user biometric ID data, and/or other user authorization level. The database 2010 can operate as a user relationships access database storing relationship permission information (e.g., associated with a relationship between the first user and the other user(s) that may result in temporary physical and/or communication access) including but not limited to party ID data, physical access permission, and/or communication access permission. This various data can be managed and collected through the various techniques described herein, including in real-time, near-teal-time, frequently, according to a schedule, and/or according to polling.

In one or more embodiments, the server 2005 can have access to or otherwise be in communication with various sensors 2015 for collecting information associated with the first and/or second users 2020, 2050, as well as collecting other information that facilitates managing temporary relationships including environmental information, security information, images, audio, pressure, tactile, light, motion, temperature, and so forth. In one or more embodiments, one or more of the sensors 2015 can be part of IoT device(s). In one or more embodiments, the server 2005 can have access to or otherwise be in communication with various on-board sensors 2030 for collecting information associated with the first and/or second users 2020, 2050, as well as collecting other information that facilitates managing temporary relationships including images, audio, location, motion, gyroscopic data and so forth. For example, the sensors 2030 can be integrated with or otherwise controlled by the first UE 2025 and/or the second UE 2055. In one or more embodiments, software applications 2035, 2060 can be resident on or accessible to (e.g., via a browser) UEs operating in the system 200, such as UE 2025, 2055. In other embodiments, the sensors 2015, 2030 can be part of equipment associated with a premises, including a WLAN, a home network, a security network, a building management system, and so forth.

As an example, a user condition for first user 2020 can be determined or estimated which in this example is an elevated heart rate and elevated blood pressure readings that is collected and stored (at least temporarily) in the database 2010. This user information can trigger a detection of a condition for the first user 2020 and cause the server 2005 to identify a second user 2050 that is to be provided a temporary relationship with the first user. For instance, the server 2005 can identify the second user 2050 (e.g., an emergency responder or police officer) that is within a threshold distance of the first user 2020 according to match/satisfaction 2090 of corresponding location information in the database 2010. The server 2005 can also use the stored authorization level for the second user 2050 (e.g., temporary relationships to be granted according to medical distress) as part of determining that the temporary relationship is warranted as illustrated by match/satisfaction 2091 of the database 2010. In this example, the second user 2050 is being granted both physical access and communication access based on the stored permissions in database 2010, and data utilized to facilitate the physical and communication access can be provided or can otherwise trigger the access as illustrated by match/satisfaction 2092, 2093.

In conjunction with the granting of the temporary relationship, the first UE 2025 can receive a notification 2080 describing the temporary relationship that has been provided, such as indicating the identity of the police officer (i.e., second user 2050) and his or her arrival time. The notification 2080 can further include other information describing the management of the temporary relationship, such as advising the first user 2020 that a physical access temporary relationship has also been granted (i.e., the front door will be automatically unlocked for the second user 2050). The notification 2080 can be generated/transmitted/presented by various devices of system 200, including generating the notification at the server 2005 and transmitting it for presentation at the first UE 2025.

Further, in conjunction with the granting of the temporary relationship, the second UE 2055 can receive a notification 2075 describing the temporary relationship that has been provided, such as indicating the identity of the person needing assistance (i.e., first user 2020), and his or her address. The notification 2075 can further include other information describing the temporary relationship, such as advising the second user 2050 of the first user's condition. In other embodiments, estimations or predictions associated with the condition can further be provided, such as determining (e.g., from various other collected data including analysis of images at the premises or other location of the first user 2020) other events that may or may not have precipitated the condition (e.g., indicating that no fall has been detected). The notification 2075 can be generated/transmitted/presented by various devices of system 200, including generating the notification at the server 2005 and transmitting it for presentation at the second UE 2055.

FIG. 2B is a block diagram illustrating an example, non-limiting embodiment of another system 210 functioning within the communication network of FIG. 1 in accordance with various aspects described herein. System 210 can manage and/or establish temporary relationships between users based on specific conditions. The system 210 includes any number of users but illustrated is the first user 2020 having the first UE 2025, the second user 2050 having the second UE 2055, and a third user 2150 having a third UE 2155. System 210 can operate in conjunction with or be integrated into system 200 of FIG. 2A, and can include hardware and/or software (which can be virtual functionality) for providing temporary relationship management, such as the user relationship server 2005 and the user information database 2010.

Similar to system 200, the server 2005 of system 210 can have access to or otherwise be in communication with various sensors 2015 for collecting information associated with the first, second and/or third users 2020, 2050, 2150, as well as collecting other information that facilitates managing temporary relationships including environmental information, security information, images, audio, pressure, tactile, light, motion, temperature, and so forth. In one or more embodiments, the server 2005 can have access to or otherwise be in communication with various on-board sensors 2030 for collecting information associated with the first, second, and/or third users 2020, 2050, 2150 as well as collecting other information that facilitates managing temporary relationships including images, audio, location, motion, gyroscopic data and so forth. For example, the sensors 2030 can be integrated with or otherwise controlled by the first UE 2025, the second UE 2055, and/or the third UE 2155. In one or more embodiments, software applications 2035, 2060, 2160 can be resident on or accessible to (e.g., via a browser) UEs operating in the system 200, such as UEs 2025, 2055, 2155.

In an example (which is a continuation of the example described with respect to FIG. 2), the detected user condition for the first user 2020 can further trigger identifying another user (e.g., the third user 2150) that is to be provided a temporary relationship with the first user and/or the second user 2050. For instance, the server 2005 can identify the third user 2150 (e.g., a neighbor of the first user 2020 that is already located at the premises). In this example, the third user 2150 may have been granted a temporary relationship which caused the third user to enter the premises (e.g., temporary communication access in the form of a message to the third UE 2155 of the third user that the first user 2020 needs assistance and/or a temporary physical access in the form of unlocking the front door of the premises of the first user). In conjunction with the granting of the temporary relationship, the second UE 2055 can receive a notification 2180 further describing the circumstances associated with the first user 2020, such as the third user 2150 being present at the location and the third user being identified as a “trusted user.” The notification 2180 can further include other information describing the temporary relationship, such as advising the second user 2050 of the first user's condition or changes thereto. In other embodiments, estimations or predictions associated with the condition can further be provided, such as determining (e.g., from various other collected data including analysis of images) other events that may or may not have precipitated the condition (e.g., indicating that no fall has been detected). The notification 2180 can be generated/transmitted/presented by various devices of system 210, including generating the notification at the server 2005 and transmitting it for presentation at the second UE 2055.

FIG. 2C depicts an illustrative embodiment of a method 230 for establishing and managing temporary relationships between users based on specific conditions and factors in accordance with various aspects described herein. The method 230 can be implemented utilizing various components and functionality, including platform 185, server 2005, database 2010, or other computing devices as shown in systems 100, 200, 210. Method 230 can dynamically assess, select, and facilitate access for one or more users, including communication and/or physical access to a particular user that is determined or suspected to have experienced an event(s) (e.g., a condition(s)).

At 2310, the method 230 determines a condition of a user. This can involve collecting and analyzing data from various sensors or sources to assess the user's current state, such as health, activity, environmental conditions, and so forth. Many of the examples described herein deal with a health-related condition of a first user, including falls, however, user conditions can include other than health related circumstances, such as a lack of heat at a premises, a car accident in which the first user was a driver or passenger, a first user stuck in an elevator, or any other condition associated with the first user that a mitigation action can be facilitated or provided through use of one or more temporary relationships with one or more other users identifiable via the database 2010.

At 2320, locations of users can be determined. For example, techniques or technologies, such as GPS or Wi-Fi triangulation, can accurately identify the proximity of the users to one another, including determining a closest emergency responder to a first user or determining whether a neighbor is present in the next-door house.

At 2330, the method 230 can evaluate whether the users are within a threshold proximity. For example, this can be utilized to determine one or more other users that can provide assistance to a first user. In one embodiment, this can be an iterative process (or done in parallel) to identify any number of potential other users. In other embodiments, proximity may not be required for triggering a temporary relationship such as automatically establishing a voice call between an emergency responder and a physician of a first user that has fallen so that the physician (who may be remotely located from the first user) can give medical advice.

In one or more embodiments, thresholds can be maintained and/or adjusted for distance settings for necessary or desired closeness for a temporary relationship to be considered. In one or more embodiments, the thresholds can be dynamically adjusted based on various factors, including the type of condition the first user is experiencing (urgent such as a fall vs. wellness check such as feeling sick), availability of other users (e.g., the first user lives in an apartment building with several neighbors vs. the first user lives in a house with only a few neighbors nearby), environment in which the condition is being experienced (e.g., first user has fallen at premises vs. first user is injured in a multi-injury event), and so forth.

As is described herein, other users (who can potentially be granted a temporary relationship) can be pre-defined users (e.g., entered or identified by the first user and stored in a database), can be public users (e.g., emergency responders, police officers, etc.), can be entities (which can be private entities (e.g., user's employer or security service) or private (e.g., police department, fire department, etc.)), and/or can be other users (known or unknown to the first user) that can provide a mitigation action(s) to the first user.

At 2340, the method 230 can assess whether a temporary relationship should be provided. For example, this can involve analyzing the user's condition and the authorization level of the other party (ies) to determine if a temporary relationship(s) is warranted.

At 2350, the temporary relationship can be facilitated. This can involve enabling access permissions, such as physical and/or communicative, based on the established temporary relationship. As described herein, physical access can include automatically or remotely unlocking a door to a premises. In other examples, the communication access can include automatically establishing a voice or video call between the first user and a second user, between the second user and a third user (e.g., an emergency responder and a neighbor of a first user that has fallen), and/or between any combination of users. Other types of access can also be provided, including granting temporary control over devices of the first user, such as control of a home network or security network of the first user. Method 230 can utilize a database that stores various user information to facilitate causing the temporary access including physical and/or communication access as described herein. For instance, user device information can be stored for providing temporary communication sessions between users.

At 2360, the method 230 can check if the condition(s) necessitating or triggering the temporary relationship(s) have been mitigated or otherwise addressed. This can involve continuously or frequently monitoring of the user's condition(s) and/or evaluating actions that have been taken by other user(s) that were granted temporary relationships. In one embodiment, this can include active monitoring, such as the method 230 transmitting a request to an emergency responder to ask whether the user has been placed in an ambulance.

At 2370, the temporary relationship(s) can be disabled. For example, once it is determined that a first user has been placed in an ambulance, then a temporary physical access can be disabled whereby the front door of the premises is remotely or automatically locked. Other factors or circumstances (which in some embodiments can be directly or indirectly determined including utilizing AI modeling) can be used to determine whether to disable a temporary relationship. It should be understood that disabling the temporary relationship can be done immediately upon detecting a mitigation action (e.g., locking the front door as soon as the first user is determined to be in an ambulance) or can be done at a future time, such as where emergency responders are still present in the premises and conducting an investigation after the first user is placed in the ambulance. This step can ensure that access permissions are revoked once the temporary need has been addressed, which includes resolving the condition, addressing the condition or some other action taken in response to the condition (which may or may not resolve the condition).

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In one or more embodiments, method 230 can allow for building up a database of various information, which can then be used to control physical access and/or communication access to a particular user. As an example, the user can be someone that has subscribed to a service provided by the platform 185 or server 2005. The access can be provided to various individuals including emergency responders, friends and family of the user, co-workers of the user, a contractor of the user, and/or any other individual, group or entity that would benefit the user by having a temporary relationship with the user.

In one or more embodiments, method 230 can provide the physical access and/or communication access according to various factors including a determined condition of the user. In one or more embodiments, method 230 can be location-based where a distance threshold between the user and other users is determined in order to grant the temporary access/relationship. In one or more embodiments, method 230 can be identity/relationship-based where a relationship between users and/or the identity of the users is determined in order to grant the temporary access/relationship. In one or more embodiments, method 230 can manage the temporary access/relationship according to various rules which can be pre-determined and/or dynamically adjusted by the user or by another individual (e.g., a caretaker of a user). In one or more embodiments, these rules can be adjusted based on AI modeling, such as changing distance proximity based on a particular user condition, a time of day, traffic in the area, or other factors which might require a closer distance for responding to the user.

In one or more embodiments, method 230 can utilize various sensors and devices that collect information for monitoring the user and/or monitoring the other users (that may be granted the temporary relationship). These sensors and devices can be owned, operated or managed by the user, by other users, and/or by third-parties, including security cameras, public devices such as traffic cameras, neighbor's door-bell camera, and so forth.

In one or more embodiments, method 230 can be executed in whole or in part utilizing applications resident on end user devices, such as mobile apps on a user's mobile phone. In one or more embodiments, Software Development Kits can be made available to facilitate providing the necessary software on end user devices or other computing devices, including home network equipment.

In one or more embodiments, method 230 can utilize various IoT devices for collecting data associated with users, including thermostats for measuring temperature in a home, motion sensors for detecting motion or a lack thereof at a premises, security cameras for capturing images of rooms in a premises (e.g., to detect whether a user has fallen), vehicle communication systems (e.g., to monitor or detect whether a driver/passenger has been in an auto accident), and so forth.

In one or more embodiments, method 230 can capture various types of data from various sources and synthesize the data to obtain or otherwise determine a more complete understanding of a user's condition. In one or more embodiments, capturing a first type of data associated with a user can trigger retrieving a second type of data associated with the user. For example, the method 230 can obtain biometric readings for a user from a wearable smart watch and based on those biometric readings the method can retrieve images at the premises, such as to detect whether the user has fallen. In other embodiments, the collection of data can be done automatically from some or all of the sources, such as polling sources or setting up a schedule for transferring data from some or all of the sources. Various schemes can be implemented for the collection of data that is used for monitoring a user and the user's condition, including real-time monitoring and near-real-time monitoring techniques.

In one or more embodiments, method 230 can store data that is indexed to a user including other users that are permitted to have temporary relationships with the user, authorization levels for those other users, rules associated with types of access to be granted for the temporary relationships, past conditions associated with the user, and so forth. The database can also include or otherwise have access to other information that facilitates providing the physical and/or communication access, including security codes or keys, passwords, authentication information, telephone numbers, end user device identification information, and any other data that would allow the method 230 to temporarily provide a particular type of physical and/or communication access associated with the user. In some embodiments, the temporary access can be with respect to other individuals associated with the user, such as temporarily establishing a video call from a police officer to the user's neighbor to check on the user while the police officer is in route to the premises.

In one or more embodiments, method 230 can use location information of the user to facilitate providing the temporary physical and/or communication access to the user, such as identifying that the user is not at home but rather is at her son's house and providing an emergency responder with temporary physical access to the front door of the son's house by remotely unlocking an electronic lock of the front door. Location detection can be performed in a number of different ways by the method 230, including monitoring of activity of end user devices of the user, such as detecting voice calls being made from the user's mobile phone when the user is located at the son's house.

In one or more embodiments, method 230 can populate or otherwise manage the database utilizing various techniques which can be manually implemented and/or automatically performed. For example, various information associated with the user and other users can be entered by the user and/or other users. In this example, a user can provide an identification of other users that may be granted temporary relationships. Data for these other users, such as telephone numbers, addresses, etc. can be provided to the database or otherwise retrieved, such as from publicly available information or private sources. User information that facilitates physical and communication access, such as electronic lock keys, passwords, telephone numbers, device MAC addresses, etc. can be obtained, such as via user input or other means that in some embodiments can be automated (e.g., retrieved from a subscriber agreement such as if the service provider of method 230 is a telecommunications service provider for the user) or manually driven. In one or more embodiments, management or maintaining relevant information for the database can be done in a number of different ways which can be automated (e.g., triggered by changes to various subscriber agreements of the user such as where the service provider associated with the subscriber agreement communicates the changes to the database) or manually driven. In one embodiment, the method 230 can monitor communication services (or the initiation thereof) by the user to detect any new or unknown devices, telephone numbers, etc., which can then be provisioned to the database, for example, after being verified by the user as another communication access possibility.

In one or more embodiments, method 230 can update the user information in the database over time as the user's information changes. In one or more embodiments, method 230 can apply AI modeling to manage the user information in the database, such as for determining when a particular location of the user is just being visited when travelling or when the particular location is more permanent to the user and requires or otherwise would facilitate operations of the method through collection of physical and/or communication access information or other data, such as the electronic key to a child's house that the parent frequently visits, monitoring data for a premises such as security images, a telephone number for a premises phone in the child's house, and so forth.

In one or more embodiments, method 230 can allow a user to enter initial information associated with themselves and/or with other users (e.g., that are to be selectively granted temporary relationships) and, from the initial information (e.g., a neighbor's name), the method can further populate the database with known information according to the name or other initial information, such as where the user and the neighbor subscribe to the same telecommunications service provider. Method 230 can apply various techniques to implement intelligent provisioning so that the database maintains up-to-date information and is robust (e.g., includes all family members rather than just one child). In one or more embodiments, method 230 can communicate with other systems to collect information for the database, such as public sources (e.g., local tax authority) and/or private sources (e.g., utility company, user's employee, etc.), which can be provided with authorization by the user and/or other users to share certain information that facilitates granting temporary physical and/or communication access.

In one or more embodiments, method 230 can utilize home networks, security networks, or other networks or systems that can have inventories or otherwise have knowledge of devices, sensors or other equipment associated with the user or other users (e.g., identity of IoT sensors that communicate with a WLAN of the premises) to populate the database and/or to collect monitoring information for the user (e.g., capturing an image of a room if the method predicts that the user may have fallen based on biometric information collected for the user (e.g., a smartwatch monitoring heart rate) indicating a potential fall).

In one or more embodiments, method 230 can collect additional information from other sources that can facilitate the temporary relationship, such as retrieving a map or room layout of the premises from a security or building management network which can be provided to a second user (e.g., an emergency responder) when the second user has been granted a temporary relationship (e.g., physical access) through remotely unlocking the front door of the premises.

In one or more embodiments, method 230 can analyze monitored data (e.g., applying AI modeling or other algorithms) to discern or determine that a potential condition may exist for the user. For example, various monitored/captured events or information can be analyzed (e.g., video of the user walking through a room that indicates that their gait stability appears impaired, a room temperature above normal that indicates that the user may not be able to reach the thermostat due to a fall or being unable to get out of bed, etc.) to indirectly determine a user's condition that may warrant a temporary relationship be established with another user, such as a communication access or physical access being provided to the neighbor to check on the user in the user's premises.

In one or more embodiments, method 230 can perform condition monitoring continuously or periodically, such as according to wearable health devices of a user that continuously or frequently monitors biometric data of the user or other devices that periodically monitor the user, such as a security camera that captures images according to a schedule or according to motion being sensed. In one embodiment as is described herein, the monitoring can be performed in a cascading or uneven fashion, such as performing continuous or periodic monitoring through one or a small number of devices (e.g., wearable health device and mobile phone) but this can then be broadened to a larger number of devices when a particular condition of the user has potentially been detected (e.g., triggering security cameras to capture images of the premises to detect if the user has fallen in a room or is unable to get out of bed).

In one or more embodiments, method 230 can determine user conditions according to user preferences or other factors. For example, a user that frequently exercises may prevent gait stability detection from being a factor in detecting a user condition or may request a high threshold of instability when analyzing gait stability. In other embodiments, a user may restrict certain information from being collected, such as not allowing images to be captured in the living room. Various rules can be put in place by the user(s) to manage privacy concerns.

In one or more embodiments, method 230 can apply historic information or other known user data to determine a user condition. For example, the method 230 can have a lower gait stability threshold for a first user that is known to have diabetes (or is determined to be wearing a diabetes monitor) as compared to a second user that is determined not to (or is unknown to) have diabetes.

In one or more embodiments, method 230 can allow for other users (e.g., those users that may be selectively granted temporary relationships with the users) to register independently of the monitored user. For example, while a user being monitored may need or asked to provide detailed information about themselves, a neighbor may be permitted to register with limited information being provided, such as a name, address, and telephone number. As described herein, the registering or otherwise populating the database with information pertinent to the user and other users can be done in a number of different ways by various sources inputting the information manually and/or automatically.

In one or more embodiments, method 230 can allow for other users (e.g., those users that may be selectively granted temporary relationships with the user) to also be monitored, such as obtaining biometric data for the other user to indicate that the person is running to the premises or has an elevated heart rate indicating that the person is nervous. These details concerning the other users may be helpful in a situation where more than one party is involved in mitigating a user's condition, such as where both a neighbor and an emergency response person have been granted temporary relationships and where the emergency response person is further granted a temporary communication session with the neighbor to instruct the neighbor as to providing comfort to the user while the emergency response person is travelling to the premises. Understanding that the neighbor is nervous can allow the emergency response person to calm the neighbor down to facilitate providing the user with comfort.

In one or more embodiments, method 230 can identify other users that are within a threshold and can most efficiently provide a mitigation action, such as establishing a temporary communication session with a child (so that the child can verbally calm the user) but not granting physical access to the premises because the method knows that the child is too far away or will be unable to move a fallen user. Continuing with this example, the method 230 can also identify an emergency responder that is 10 minutes away and establish both a temporary communication session with a mobile phone of the user as well as physical access with the user by unlocking the door to the premises.

In one or more embodiments, method 230 can provide temporary communication access without the need for the user or the other user to initiate the communication session, such as having a voice call automatically placed through the home network utilizing a home network device so that a user that has fallen can speak with the user's neighbor to obtain assistance. In this example, the temporary relationship can further include physical access to the user by remotely unlocking the front door of the premises so that the neighbor can enter the premises.

In one or more embodiments, method 230 can record or otherwise log temporary relationships that are being established including criteria or factors upon which the decision was made. This can facilitate record keeping with respect to emergency responders that are provided with a temporary relationship, such as accurately indicating when the emergency responder was first contacted, when the emergency responder entered the premises, and so forth. This record keeping can facilitate any investigations that may arise after an event where mitigation actions occurred.

In one or more embodiments, method 230 provides for user information to be presented or otherwise relayed to the emergency responder, such as providing a paramedic with a user's health history (e.g., the user has diabetes) when the emergency responder is provided with a temporary relationship to enter the premises (e.g., remotely unlocking the front door) and the detected condition is a fall of the user. In this example, other collected user information (e.g., near the time of the suspected event) can be provided to the emergency responder such as indicating that there was no motion detected for the last hour by cameras/motion sensors in the premises, which may indicate that the user fell more than an hour ago or was possibly unconscious.

In one or more embodiments, method 230 can populate the database with information for other users (e.g., those users that may be selectively granted temporary relationships with the users) that are groups of users or entities, such as a police department, ambulance company, fire department, and so forth. In this example, the entity can provide global information which can then be used for selectively providing temporary communication and/or physical access to individual members of the entity. For example, a police department can provide or determine proximity information for police officers (e.g., in real-time) to allow the method 230 to establish a temporary relationship between the user and the closest or most available police officer.

In one or more embodiments, method 230 can allow a second user to be notified of one or more third users that are authorized for temporary relationships with the first user. This technique can facilitate the second user in performing a mitigation action, such as having a neighbor (i.e., a third user in this example) secure the first user's dog while an emergency responder (i.e., the second user in this example) provides healthcare to the first user.

In one or more embodiments, method 230 can utilize, populate and manage a single database that stores user information for all types of users, including those users that would be experiencing a condition and those users that would be granted temporary relationships. Although, other embodiments can utilize any number of databases for managing the various user information described herein.

In one or more embodiments, authorization levels for the second or third users can dictate or otherwise control the type of information (associated with the first user) that the second or third users are exposed to or otherwise provided. For example, method 230 can allow a top level authorization be provided to an emergency responder with respect to a first user, which can include entering the premises through a remotely unlocked front door, automatically establishing a voice call with the daughter of the first user, and presenting medical history data for the first user on an end user device of the emergency responder. In contrast, a neighbor may be granted physical access for entering the premises through a remotely unlocked front door but not provided the first user's medical history. Continuing with this example, a landscaper who is working in the yard of the first user may be given temporary communication access such as automatically establishing a voice call from the daughter of the first user to the landscaper so that the landscaper can verbally check on the first user but not provided the first user's medical history, nor provided access through the front door.

In one or more embodiments, method 230 can facilitate temporary physical and/or communication access through communication with other systems, including third-party systems. For instance, the method 230 can provide physical access by automatically unlocking the front door and also communicating with an alarm company to shut off the alarm. In another embodiment where method 230 is provided by an entity that is not a communications service provider then the entity can communicate with the communications service provider to establish any temporary communication sessions, such as between the first user and a neighbor.

In one or more embodiments, method 230 can provide the first user with messaging or other notification as to any users being granted a temporary relationship and information describing the temporary relationship, such as detecting that a user has fallen, triggering a temporary relationship with an emergency responder to visit the premises, triggering temporary physical access to the premises by unlocking the front door, and presenting an audio message on a home entertainment system that notifies the first user that the emergency responder is on the way. This notification can provide further details regarding the temporary relationship, such as an alert that “police officer Adam Smith is on his way, will be arriving in approximately 5 minutes, and that the front door will be automatically unlocked in 4 minutes.”

In one or more embodiments, method 230 can implement a temporary relationship for a second, third or any number of users that are not in proximity to the first user. For example, method 230 can detect that a user has fallen, trigger a temporary relationship with an emergency responder to visit the premises, trigger temporary physical access to the premises by unlocking the front door, present an audio message on a home entertainment system that notifies the first user that the emergency responder is on the way, and automatically establish a voice call with the daughter of the first user that is located remotely from the first user.

In one or more embodiments, method 230 can select users for temporary relationships according to the detected condition of the first user and/or other determined circumstances, such as detecting that a user has fallen, triggering a temporary relationship with an emergency responder to visit the premises, triggering temporary physical access to the premises by unlocking the front door, and automatically establishing a voice call between the emergency responder and a physician of the first user so that the physician can provide medical guidance to the emergency responder.

In one or more embodiments, method 230 can dynamically adjust authorization levels (e.g., according to confirmation from the first user) based on various factors including an analysis of, or a determined success of, circumstances and/or mitigation action(s) taken in conjunction with a temporary relationship. For example, it may be determined (which can include via an analysis performed utilizing AI modeling) that establishing a temporary relationship for a neighbor to physically access a first user's premises for a wellness check is predicted to be (or has been shown in the past to be) more efficient or effective than establishing a temporary communication session with an emergency responder that is 30 minutes away. In this example, the authorization level of the neighbor may be adjusted so that physical access to the premises is granted temporarily for particular detected health conditions.

FIG. 2D shows a system 240 for multi-factor authentication involving various components and their interactions. As explained herein, system 240 can be used with any of the systems and processes described herein to provide authentication, including in methods where temporary relationships are being provided between users. In this example of FIG. 2D, it is two-factor authentication being utilized, however, any number of authentication steps can be utilized including a dynamic number that is adjusted according to confidence level of one or more previous authentication steps. The system 240 can include an authentication server 2405, an authentication database 2410, an end user device 2425 (e.g., a smartphone, desktop computer, laptop computer, smart television, and so forth), a user 2420, a user authentication APP 2417, a banking APP 2427 (or other application being initiated by the user 2420), on-board sensors 2430, and external sensors 2415. The system 240 also includes data elements such as User ID User1, User Location x, y, z, Biometric ID image, Password Jen5309, Comm Address 20.345.209, Sensor ID abc123, Location x, y, z, Location Range x1, y1, z1-x2, y2, z2, Status Active, and Address 12345678890. Additionally, the system 240 features confidence/requirement data 2470 such as 1st Factor Confidence (1FC) and 2nd Factor Requirement (2FR) which in some embodiments can be generated according to the functionality described herein.

The authentication database 2410 can store various user-related data and sensor-related data as described herein. This database 2410 can be used for verifying user identities and managing authentication processes.

The authentication server 2405 can communicate with the authentication database 2410 and/or other components to manage the authentication process. The server 2405 can analyze the first authentication information, such as an image of the user, to determine a first authentication and a confidence level as shown by reference number 2450. Based on the confidence level, the server 2405 can select a type of second authentication information required and can provide a request for this information to the end user device 2425. As shown in this example, the server 2405 can analyze the second requested authentication information, such as a password, to determine a second authentication. For instance, the baseline password is illustrated as “Jen 5309”. The server 2405 can authorize or pass the second authentication based on the user input of “Jen5” as shown by reference numeral 2460. In this example, due to the first authentication of a 90% match (i.e., image recognition of the user 2420) being under the required first factor confidence of 100%, a second authentication was required. However, due to the 90% match falling within the threshold range of 75%-99%, the second authentication was provided with a required completeness threshold of 50% of the password. The user input of “Jen5” satisfied the 50% completeness threshold and thus the second authentication was provided or otherwise confirmed. In this example, the confidence level calculated for the first authentication information (the image of the user 2420) by the server 2405 is utilized to determine whether a second authentication step is required, as well as the completeness threshold that is to be applied to the second authentication step. In this example, a confidence level of under 75% would have resulted in a required completeness threshold of 100% for the second authentication information (e.g., the password). In other embodiments, the confidence level can be utilized to calculate a completeness threshold that is to be applied to a second authentication step, where the second authentication step is always required.

In this example, the end user device 2425, operated by user 2420, includes the authentication APP 2417 and the APP 2427 for which authentication is required. It should be understood that APP 2427 can be any type of App or other functionality or service which requires authentication. For purposes of simplicity, the end user device 2420 is illustrated twice in FIG. 2D representing each of the authentication steps. In other embodiments, the APP 2427 can be executed from a different device that provides the first and/or the second authentication information, such as requiring the user 2420 to send the second authentication information (e.g., a password) via the user's mobile phone when the App is initiated in another device (e.g., a smart TV or a desktop computer of the user). The APP 2417 facilitates the authentication process by interacting with the server 2405 and the authentication database 2410. In one embodiment, the end user device 2425 can include on-board or accessible sensors 2430, which can collect additional data such as location, motion, and biometric information (e.g., image, fingerprint, voice, etc.) to support the authentication process. In one embodiment, the external sensors 2415 can provide supplementary data to the server 2405, enhancing the accuracy and reliability of the authentication process. These sensors can include microphones, cameras, temperature sensors, and motion sensors, among others.

In one embodiment, the system and methodology can overcome a problem which exists in that a user may need to authenticate themselves for using an App, for example, on a wireless device. In doing so, biometric identification techniques, such as facial recognition may be used. However, there is an increasing potential for users identities to be hacked, and for a bad party to mimic a true user's identity by falsifying their biometric information, such as their face print. Therefore, there can be a desire for a second (or more) factor authentication. However, depending on the level of accuracy of the first factor biometric authentication, a second factor authentication may not need to be complete depending on the level of confidence of the first factor. In one embodiment, the degree of completeness of a second (or more) factor authentication can be based on the level of confidence calculated for the first (or previous) factor.

In one embodiment, the system and methodology can provide that a user may be equipped with a user device such as a wireless device that is in communication with a network. The user device is equipped with onboard sensors, such as a camera, microphone, and location, motion, gyroscopic sensors, and others. There may also exist external sensors in the location that is proximate to the location of the user. These external sensors may also be used for the purpose of detecting biometric information for the user. So, for instance, either the user's onboard camera or an external camera may be used to capture a video of the user within a location that may be subsequently used for the purpose of facial recognition.

In one embodiment, the system and methodology can provide that each external sensor may be registered in a database that includes a unique sensor ID and location of the sensor, a range of operation location coordinates for the sensor, status of the sensor, and/or a communication address for the sensor. The user device location may be continually or frequently updated and sent to a user authentication server via a user authentication app. The user authentication server may subsequently compare the location of the user device with the location range of each sensor to determine any external sensors that may be in range of operation of the location of the user device. Therefore, in one or more embodiments, when the user authentication app is invoked, it may use data collected by any external sensors that are in range, such as a video stream from a nearby camera.

In one embodiment, the system and methodology can provide a user record which may be created in the authentication database for each user. The user record may include a unique user ID and a location of the user, as indicated by the location of the user device. This location may be continually updated as the location of the user device changes. The user record may also include data describing a biometric ID that is unique to the user. For example, the data may describe a face print of the user, which may be obtained by known methods. The user record may also include a secondary or tertiary authentication data. This may include, a secondary biometric ID, or a secondary non-biometric ID, such as a password. The user ID record may also include a communication address for the user device.

In one embodiment, the system and methodology can provide that the user device may also include another App that has a functional utility, but needs authentication of the user. In this embodiment, an App is used that is in communication with a server (e.g., a banking server for a banking App). It should be noted that more than one such App may be used, and in communication with the user authentication App, such that the user authentication App may serve as the authentication means for all such Apps that are used by the user that require such authentication. For example, a banking App may be invoked by the user and identify a need for authentication. It sends a request to the user authentication App to conduct the authentication. In one embodiment, the first factor authentication may be the biometric identification authentication, such as facial recognition authentication.

In one embodiment, the system and methodology can provide a user authentication App which may use either an onboard sensor, such as the onboard camera, or an external sensor that is detected to be within range of the user to capture, in this case, a facial image of the user. The image may be sent to the authentication database for comparison of the image captured versus the biometric ID image stored in the authentication database. The comparison of the image captured to the biometric ID stored, may be determined to match with a specific level of confidence less than 100% confidence. This level of confidence may be calculated, for example, based on the number of marker matches between the image captured, and the face print stored for the user. The user authentication server may be configured to have one or more thresholds that determine next steps for a second factor authentication based on the confidence level achieved.

In one embodiment, the system and methodology can provide or otherwise calculate a confidence level for authentication information based on location data. For example, a background of a captured image can be analyzed to determine a location of a user such as detecting books in the background when the known location of the user is in a library.

In one embodiment, the system and methodology can provide configuration settings which may be stored as rules in the authentication database, so that the user authentication server has access to the rules, such that it may compare the results of the first factor authentication to determine what rule to apply to the completeness of the credentials submitted for the second (or more) factor authentication. As an example, it may be that the image captured of the user may not capture all of the markers that are stored for the face print. Therefore, the first factor authentication would not yield a 100% confidence match. Similarly, an image of the user that is falsified may be imperfect and not result in a 100% confidence match. In either case, for example, a first factor confidence of, say, 90% may be achieved. The rules may be consulted to determine that in such a case, the user must subsequently enter at least 50% of their password manually in order to pass the second factor authentication.

In one embodiment, the system and methodology can provide a user authentication App which may subsequently prompt the user, according to the rules, to enter a password as a second factor requirement for authentication. In this example, the user must enter at least the first 50% of the password to pass the second factor authentication. Therefore, once a match of the beginning of their password is determined, the second factor authentication may be determined to pass, and the user is authenticated for use of the banking or other App with the banking or other server. Other similar partial second factor authentication pass rules may apply, which may include partial biometric, or other non-biometric authentication techniques.

In one embodiment, the system and methodology can provide that the calculated confidence level is used to determine a type of second (or more) authentication information to be obtained. For example, if a low confidence level is obtained for the first authentication information (e.g., a user image which does not match or has little or a low match with a baseline image of the user) then the requested second authentication information can be for data that is more difficult to hack or defraud, such as a 100% match on a user password.

FIG. 2E illustrates a method 250 for multi-factor authentication, which can include obtaining first authentication information associated with a user at 2510. This can be done in a number of different ways including when a user initiates an application on an end user device or on another device. This information can be analyzed to determine a first authentication and to assess a confidence level for the first authentication at 2520.

In one embodiment, based on the confidence level, the system can determine a type of second authentication information that is to be requested or obtained at 2530. At 2540, the system can then obtain the second authentication information and at 2560 can evaluate whether the user (or the use of the application by the user) is to be authenticated based on this second authentication information.

In one embodiment at 2560, a completeness threshold can be utilized for determining whether the second authentication is to be provided. For example, at 2570 if the authentication is successful, the user can be granted access to application functions, such as the application that the user has initiated at end user device or the other device. Steps of method 250 can be repeated such that the multi-factor authentication is any number of required authentication submissions.

In one embodiment, the end user device associated with the user is a first end user device, and the first authentication information is received from a second end user device of the user that is different from the first end user device (e.g., a second end user device where a user has initiated an application which requires authentication for use). In one embodiment, the first authentication information includes an image of the user, and the second authentication information includes information input by the user at the first end user device.

In one embodiment, the completeness threshold is based on a match percentage for the information input by the user as compared to baseline information. In one embodiment, baseline information can be obtained from publicly available sources. In one embodiment, baseline information can be obtained from stored information in a database (e.g., securely stored baseline information that a user may provision to the system such as images, biometric data, fingerprints, passwords, personal data, and so forth).

In one embodiment, the first authentication results in a temporary authentication enabling use of an application by the user for a time period, and the request for the second authentication information is provided to the end user device before expiration of the time period. In one embodiment, the use of the application by the user is at a second end user device, and the first authentication information includes biometric data of the user. In one embodiment, both the selecting of the type of second authentication information and the completeness threshold are based on the confidence level, which is calculated as a quantified value.

In one embodiment, a location of the user can be determined and a request can be transmitted or provided to a sensor according to the location to capture the first authentication information associated with the user. In one embodiment, the sensor includes a camera at the location of the user. In one embodiment, the end user device associated with the user is a first end user device, the first authentication information is received from a second end user device of the user that is different from the first end user device, and the first authentication information comprises biometric information of the user. In one embodiment, analyzing the first authentication information to determine the confidence level for the first authentication can include or otherwise be based on applying an AI model to the first authentication information and to other information associated with the user, the application, the location or other factors (e.g., characteristics that can increase or decrease an assessed risk of fraud).

In one or more embodiments, a method for multi-factor authentication is provided. The method includes: obtaining, by a processing system including a processor, first authentication information associated with a user; analyzing, by the processing system, the first authentication information to determine a first authentication and to determine a confidence level for the first authentication; selecting, by the processing system, a type of second authentication information from among a group of different authentication queries for a second authentication based on the confidence level; providing, by the processing system, a request for the second authentication information to an end user device associated with the user; receiving, by the processing system, the second authentication information from the end user device; authenticating, by the processing system, the user according to the second authentication information based on a completeness threshold, where the completeness threshold is based on the confidence level and where the first authentication information is obtained from at least one of an onboard sensor of the end user device or an external sensor in communication with the processing system.

In one or more embodiments, a method for authenticating a user can include various steps or combinations of steps including one or more of: receiving, by a network node, a first authentication attempt; determining, by the network node, an imperfect confidence in the first authentication attempt; determining, by the network node, a confidence rule for a second authentication; requesting, by the network node, a second authentication attempt; receiving, by the network node, the second authentication attempt; and, authenticating the user, by the network node, if the confidence rule for the second authentication is satisfied. The first authentication attempt can be a biometric authentication attempt. The confidence rule for the second authentication can be a requirement for a first portion of a credential. The confidence rule for the second authentication can be a requirement for a confidence match of a credential.

FIG. 2F illustrates a system 260 for user authentication based on unexpected stimuli 2665. In this manner, the stimuli 2665 can be presented (and reacted to) seamlessly or otherwise transparently, such as without requiring any particular interaction by the user 2620 (as compared to a user inputting a password or posing for an image to be captured). The system 260 comprises several components: an authentication database 2610, an authentication server 2605, an application server 2650 (e.g., a video content server), an external sensor 2670 (e.g., a camera), an end user device 2625, on-board sensor(s) 2630, an authentication APP 2617, and an application 2627 (e.g., video content or streaming App).

The authentication database 2610 can store various data related to user authentication. This can include user-specific information such as user ID, device address, location, stimuli data, and/or stimuli response/reaction data. Additionally, the authentication database 2610 can store information about external sensors, including sensor ID, address, location, and/or range.

The authentication server 2605 can be responsible for managing or facilitating the authentication process. For example, the authentication server 2605 can communicate with the authentication database 2610 and other components to verify user identities. In one or more embodiments, the server 2605 sends and/or receives data or other information related to stimuli (e.g., stimulus 2665) and/or user responses/reactions, ensuring that the authentication process is secure and accurate.

The end user device 2625 can be equipped with various on-board sensors 2630, such as a camera, microphone, biometric sensors, motion sensors, and/or a gyroscope. These sensors 2630 can collect data about the user's environment and responses or reactions to stimuli. The end user device 2625 can also host the authentication APP 2617 and/or the video content APP 2627 (or other Application/Service for which authentication is being sought), which work together to facilitate the authentication process.

The video content server 2650 (or other App server) provides video content (or another service or functionality) to the end user device 2625. In one embodiment, during the authentication process, the server 2650 can insert visual stimuli (e.g., stimulus 2665) into the video stream. These stimuli are designed to be noticeable but unexpected, prompting a response or reaction from the user. In other embodiments, the server 2650 can provide instructions or information that allow, facilitate or cause the insertion of visual stimuli into the video stream. In other embodiments, the visual stimuli can be presented in conjunction with images of the video stream through an overlay technique such as performed by the end user device 2625.

In one embodiment, various information such as position, shape, size, color, brightness and/or other visual characteristics can be selected or determined for the stimuli, such as selecting particular characteristics so that a user more easily sees the stimulus even when it is placed in an image(s) with other objects. As an example, a stimulus which appears as a bright star-like shape can be presented in images of a dark night sky (i.e., the moon and stars are not seen) to facilitate a user seeing the stimulus so that the user's reaction can be captured. However, the same stimulus may not be selected for images in a night sky where stars are seen since the stimulus may blend in too easily or otherwise not be evident to the user. Various techniques can be utilized for selecting a particular stimulus and its characteristics including applying AI modeling to determine stimuli which are more easily detected by a particular user (which can include an analysis of or prediction for the perception of the particular user). In one embodiment, historical data collected for types and characteristics of stimuli, as well as user reactions (e.g., detected user gaze at positions in the image) can be analyzed, including by AI modeling.

In one embodiment, the external camera 2670 (or other external sensor(s)) can capture the user's response or reaction to stimuli (e.g., stimulus 2665). Embodiments herein describe images and cameras being utilized for obtaining a captured reaction of a user 2620, however, other types of reactions can also be captured including audio, biometrics (e.g., elevated heart rate) or other detectable characteristics of the user. In one embodiment, the sensor 2670 (e.g., a camera) can be registered or otherwise known to the authentication database 2610 with specific details such as its ID, address, location, and/or operational range. In one embodiment, the camera 2670 can provide supplementary data to enhance the accuracy of the authentication process.

In operation, the authentication server 2605 can cause presentation of one or more stimuli that is experienced by the user 2620. This can be done in a number of different ways including instructing the end user device 2625 (or another device) to present the stimulus such as at a particular time and/or at a particular position on the display (or in the image(s)/frame(s)). In other embodiments, the stimulus or information describing the stimulus can be sent to the end user device 2625 and/or sent to the video content server 2650 (or another device) for insertion into the video stream or presentation at the display. For instance, the stimulus can be presented to the user through use of the video content APP 2627. In other embodiments, the stimulus can be presented to the user in other ways (that may or may not utilize the end user device 2625) which can include being overlayed or inserted into the video frames. For example, external stimuli devices can be utilized for presenting a stimulus to a user, such as a speaker, a light, a vibration device, and so forth.

The user's response or reaction can be captured in a number of different ways including recording images and/or audio of the user 2620 around the time period that the stimulus is presented. For example, on-board sensors 2630 and/or external sensors 2670 (which can include cameras, motion detectors, and/or microphones) can capture user reactions. This response or reaction data can be sent back to the authentication server 2605, where it is compared to the stored baseline data in the authentication database 2610. If the response or reaction of the user matches or correlates with expected baseline data, such as within a confidence threshold (e.g., predefined or dynamic), then the user 2620 can be authenticated and granted access to the requested functions or applications.

The visual stimulus 2665 is shown as an object inserted into the video content 2660, prompting the user to react. The user's reaction, such as a change in gaze direction, a facial expression, a movement, etc., can be captured and can be analyzed to determine if it matches the expected response reaction stored in the authentication database 2610. If the user's response meets the confidence threshold, the authentication is successful, and the user is granted access (or continued access) to the application or service.

Baseline information can be obtained in a number of different ways including at random times (e.g., unknown to the user) for various types of stimuli when a user is utilizing various types of applications. For instance, the system and methodology can periodically update baseline reactions by periodically presenting stimuli and capturing reactions when the user has already been authenticated for utilizing the particular application or the identity of the user has already otherwise been confirmed.

In other embodiments, baseline information can be a predicted reaction of the user to a particular stimulus which can be predicted based on various information including a history of user reactions to other stimuli. As an example, the prediction can be made, such as via AI modeling, previously and stored in the database 2610 and/or can be made in real-time or near-real-time such as upon receiving the captured user reaction, determining that a baseline captured user reaction does not exist and generating a predicted user reaction at the server 2605. In one embodiment, AI modeling can be utilized to predict the user reaction which is then utilized for the baseline reaction. In this example, the accuracy of the predicted user reaction when compared to a captured user reaction can further be utilized for training of the AI model or other AI fine-tuning functions.

In one embodiment, the system and methodology can utilize both actual captured baseline reactions and predicted baseline reactions for authentication purposes. In one embodiment, a confidence or accuracy level in matching a baseline reaction with a captured reaction can cause or otherwise trigger a subsequent authentication step which may switch from an actual captured reaction to a predicted user reaction or vice versa and/or may switch to a different type of stimulus (or different characteristics of the stimulus).

In one or more embodiments, the application that is being accessed by the user and for which authentication is required, can be any type of application (or service which is being referred to herein as an application) including video streaming, gaming, banking, human resources, an entity's intranet, a VPN, e-commerce, and so forth.

FIG. 2G illustrates a system 270 for user authentication based on an unexpected stimuli. The system 270 can include several components such as an authentication database 2710, an authentication server 2705, an end user device 2725, on-board sensors 2730, an authentication APP 2717, a video content APP 2727 (or other application/functionality providing services that require authentication), a video content server 2750 (or other application server depending on the service being sought by the user), an external sensor(s) (e.g., camera) 2770, an external speaker 2760, and an external light 2765. In other embodiments, other types of external stimuli devices can be utilized such as a vibration device, an image projector, and so forth.

The authentication database 2710 stores various data related to user authentication which can include user-specific and/or device-specific information such as user ID, device address, location, stimuli data, and stimuli response/reactions data. Additionally, it stores information about external sensors and/or devices, including sensor ID, address, location, and range.

The authentication server 2705 is responsible for managing the authentication process. It communicates with the authentication database 2710 and other components to verify user identities. The server 2705 sends and receives data related to stimuli and user responses, ensuring that the authentication process is secure and accurate.

The end user device 2725 is equipped with various on-board sensors 2730, such as a camera, microphone, biometric sensors, motion sensors, and a gyroscope. These sensors 2730 can collect data about the user's environment and responses to stimuli. The end user device 2725 also hosts the authentication APP 2717 and the video content APP 2727, which work together to facilitate the authentication process.

The video content server 2750 provides video content to the end user device 2725 or to some other display such as a smart TV (not shown). During the authentication process, the server can 2750 can insert or cause the insertion of visual stimuli into the video stream or on the display and/or cause other devices (e.g., speaker 2760 and/or light 2765) to generate or emit one or more stimuli (e.g., a flashing light in the room, a shouted phrase from a speaker). These stimuli are designed to be noticeable but unexpected, prompting a response or reaction from the user. In some embodiments, the reaction can include the user speaking and stating information which can also be analyzed through voice print analysis and/or determining an accuracy of the spoken information (e.g., a user stating his full name and that he or she is authorized to utilize the application).

In one embodiment, the external camera 2770 is an additional sensor that can capture the user's response/reaction to stimuli. For example, the camera 2770 can be registered in the authentication database 2710 with specific details such as its ID, address, location, and operational range. The camera 2770 provides supplementary data to enhance the accuracy of the authentication process.

In one embodiment, the external speaker 2760 and the external light 2765 are additional external devices that can produce stimuli, which can be in place or in conjunction with placing the stimulus in or overlayed on the video frames. For example, the external speaker 2760 can emit sounds including spoken or synthesized words, while the external light 2765 can produce visual stimuli. For instance, these devices 2760, 2765 can be registered in the authentication database 2710 with specific details such as their ID, address, location, and operational range.

In operation, the authentication server 2705 triggers or otherwise causes presentation of a stimulus at a known time and known location, such as through speaker 2760 and/or light 2765. The user's response/reaction can be captured in a number of different ways including via on-board sensors 2730 and/or external camera 2770. This response/reaction data can then be sent back to the authentication server 2705, where it is compared to the stored baseline data in the authentication database 2710. If the response matches the expected baseline data (e.g., within a predefined or dynamic confidence threshold), the user is authenticated and granted access or continued access to the requested functions or applications.

FIG. 2H illustrates a system 280 for user authentication based on a stimuli which is one or more objects that are being presented in video content being watched by the user 2820. The system 280 includes several components including an authentication database 2810, an authentication server 2805, an end user device 2825, on-board sensors 2830, an authentication APP 2817, a video content APP 2827, a video content server 2850, and an external camera 2870.

The authentication database 2810 stores various data related to user authentication. This includes user-specific information such as user ID, device address, location, stimuli data, and stimuli response/reaction data. Additionally, it stores information about external sensors, including sensor ID, address, location, and range.

The authentication server 2805 is responsible for managing the authentication process. It communicates with the authentication database 2810 and other components to verify user identities. For example, the server 2805 determines one or more stimuli that are present in video frames and that are to be presented during video streaming. This determination can include a predicted time period of the presentation and/or a predicted location on the display. For example, the server 2805 can identify a particular type of car that will be shown in video frames at time X and further determine that the user has an interest in that type of car so that the user is predicted to gaze towards the car during its presentation. This can be part of the server 2805 sending and receiving data related to stimuli and/or user responses/reaction, ensuring that the authentication process is secure and accurate.

The end user device 2825 is equipped with various on-board sensors 2830, such as a camera, microphone, biometric sensors, motion sensors, and a gyroscope. These sensors 2380 can collect data about the user's environment and responses/reactions to stimuli appearing in video content including based on instructions from the server 2805 as to a time period for collecting or capturing the user's reaction. The end user device 2825 can also host the authentication APP 2817 and the video content APP 2827, which work together to facilitate the authentication process. In one embodiment, the server 2805 can apply AI models or other pattern recognition techniques to video frames of video content to determine or otherwise identify stimuli (already present as objects in the video frames) for use in an authentication process. In one embodiment, selecting the objects from the video frames can be based on AI modeling that predicts objects which are likely to be seen or noticed by the user 2820 or likely to capture the gaze of the user. In other embodiments, the objects can be selected based on historical reactions of the user 2820 to similar objects in other video content. For example, if the user 2820 typically turns away from a violent scene, this can be utilized as the stimulus (or an object presented during the scene can be considered the stimulus) to determine if the user has turned away from the video content presentation, which may be a match to the user's baseline reaction for violent scenes.

In one embodiment, the video content server 2850 can provide various data or metadata for the video content including timing data to the authentication server 2805 to facilitate selecting stimuli from objects already present in the video frames. During the authentication process, the server can insert visual stimuli into the video stream. These stimuli are designed to be noticeable but unexpected, prompting a response or reaction from the user.

In one embodiment, the external camera 2870 is an additional sensor that can capture the user's response or reaction to the stimuli. It can be registered in the authentication database 2810 with specific details such as its ID, address, location, and operational range. The camera 2870 provides supplementary data to enhance the accuracy of the authentication process.

In operation, stimulus is presented or otherwise identified in the video content 2860. The user's response or reaction is captured by the on-board sensors 2830 and/or the external camera 2870. This response/reaction data is then sent back to the authentication server 2805, where it is compared to stored baseline data in the authentication database 2810, such as previously captured user reactions to similar stimuli in similar situations (e.g., same genre of video content, same time of day, etc.). In other embodiments, the comparison can be based on predicted user reactions, which in some embodiments can be predicted by AI modeling. If the response/reaction matches the expected baseline data (e.g., within a predefined or dynamic confidence threshold), the user 2820 is authenticated and granted access to the requested functions or applications.

In one embodiment, the system 280 utilizes a predicted gaze area 2865 for the user reaction comparison. For instance, the system 280 can include a feature for predicting the user's gaze area 2865, as indicated by the “PREDICTED GAZE AREA FOR USER abc123” label. This feature helps in determining where the user 2820 is likely to look with respect to the video frames when a stimulus is being presented, further enhancing the accuracy of the authentication process. In this example, it is predicted that the gaze area 2865 would be one of the individuals positioned near the front end of a car as opposed to a group of individuals at a rear end of the car in the video 2860 (a frame of which is illustrated in FIG. 2H). This prediction can be made (including via AI modeling) in a number of different ways and based on various factors including past user gaze when similar objects are shown in a scene, a user's interest in a particular actor in video content, a user's interest in particular objects (e.g., a type of a car), and so forth.

FIG. 2I illustrates a method 290 for authenticating a user based on their response or reaction to a stimulus such as during the user accessing a particular application or functionality, such as a video streaming application on a mobile phone or smart TV. The method 290 begins with or otherwise includes storing or obtaining baseline data at 2910, which includes the user's known or predicted responses to various stimuli. This baseline data is used for comparison during the authentication process. For example, the baseline data can be captured during other video streaming when a user's identity has already been confirmed. In other embodiments, the baseline data can be predicted data, such as based on AI modeling applied to various information including a user's reactions to other types of stimulus. In other embodiments, the predicted reactions can be determined from other user's captured reactions to a similar or same stimulus where the user and the other user's have similar characteristics or behavior patterns.

The next step involves receiving an authentication request at 2920. This request is typically initiated when a user attempts to access a secure application or system. Upon receiving the authentication request, the system proceeds to present a stimulus to the user at 2930. The stimulus can be visual, auditory, or any other form that is unexpected but noticeable to the user. The stimulus can be presented in a number of different ways including within or overlaying video frames on a display, at a separate stimulus device (e.g., a light or speaker), and so forth. In one embodiment, the stimulus can be an already existing object that is to be shown in a video frame(s) which is identified or selected as an appropriate stimulus, such as a car that is known to appear in video frames at time X and for which the user is determined to have an interest in the type of car.

Once the stimulus is presented, the system obtains the user's response or reaction to the stimulus at 2940. This response or reaction can be captured through various sensors (including on-board sensors and/or external sensors), such as cameras, microphones, or biometric sensors, depending on the nature of the stimulus and the user's environment.

The obtained user response or reaction is then compared to the stored baseline data at 2950. This comparison can determine whether the user's response or reaction matches an expected or predicted response based on the baseline data. The system evaluates the similarity between the user's current response and the baseline response to make an authentication decision. In one embodiment, if the comparison satisfies a predefined or dynamic confidence threshold, the system authenticates the user at 2960. In one embodiment, AI modeling can be utilized to establish the confidence threshold, such as based on a type of application that is being accessed (e.g., banking application versus video streaming), a location of the user (e.g., at home versus in a car in an area not typically visited by the user), a time of day (midnight versus middle of the day), or other circumstances that can be utilized for predicting a risk of potential hacking. Upon successful authentication, the user is granted access or continued access to the requested functions or application at 2970. In one embodiment, if the user's response does not meet the confidence threshold, the authentication process may be repeated (e.g., utilizing a different stimulus), or the user may be denied access.

This method 290 ensures that the authentication process is both secure and user-friendly, as it leverages the user's natural responses to unexpected stimuli without requiring explicit interaction or additional authentication steps.

In one embodiment, a method for authenticating the identity of a user includes storing, by a network node, data describing the user's known response to an unexpected stimulus; receiving, by the network node, a request for user authentication on a device; sending, by the network node, data describing a stimulus; receiving, by the network node, data describing the user's response to the stimulus; comparing, by the network node, the data describing the user's response to the stimulus to the data describing the user's known response to an unexpected stimulus; and authenticating the identity of the user, by the network node, if a confidence rule for the comparison is satisfied. In one embodiment, the stimulus can be explicit such as text written to the user and inserted or overlayed on video frames. In one embodiment, the stimulus can be implicit such as an object (or audio) that exists in video content, such as a scene with a large explosion. In one embodiment, the confidence rule can be adjusted based on user biometric data.

In one embodiment, a method for authenticating the identity of a user can include storing, by a user authentication server, data describing the user's known response to an unexpected stimulus in an authentication database; receiving, by the user authentication server, a request for user authentication from a user device; sending, by the user authentication server, data describing a stimulus to the user device, where the stimulus is presented to the user during their interaction with an application on the user device; receiving, by the user authentication server, data describing the user's response to the stimulus from the user device; comparing, by the user authentication server, the data describing the user's response to the stimulus to the data describing the user's known response to the unexpected stimulus stored in the authentication database; and authenticating the identity of the user, by the user authentication server, if a confidence rule for the comparison is satisfied.

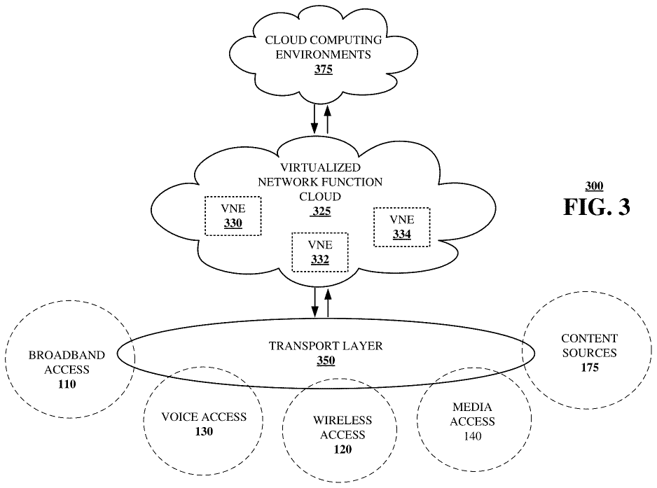

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions described herein.

For example, virtualized communication network 300 can facilitate in whole or in part receiving, over a network, a captured reaction of a user experiencing a stimulus, where the stimulus is presented during accessing of an application by the user at an end user device; analyzing the captured reaction by a comparison with a baseline reaction of the user that is previously obtained; and providing an authentication over the network to the end user device in response to the comparison.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

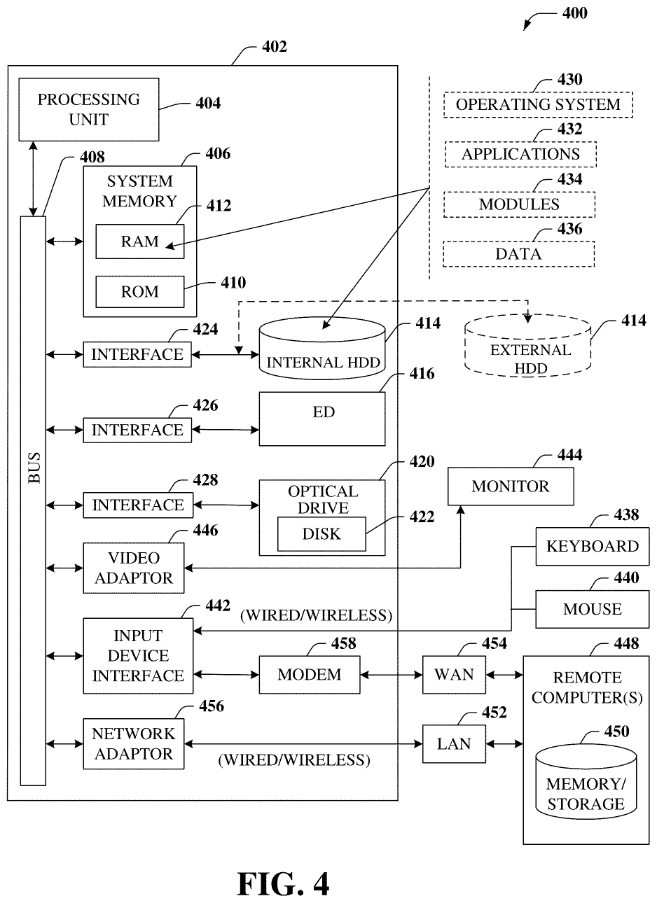

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software.

For example, computing environment 400 can facilitate in whole or in part receiving, over a network, a captured reaction of a user experiencing a stimulus, where the stimulus is presented during accessing of an application by the user at an end user device; analyzing the captured reaction by a comparison with a baseline reaction of the user that is previously obtained; and providing an authentication over the network to the end user device in response to the comparison.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), an external drive (ED) 416, (e.g., to read from or write to) and an optical disk drive 420, (e.g., reading a CD-ROM disk 422 or, to read from or write to other high-capacity optical media such as the DVD). The HDD 414, magnetic ED 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

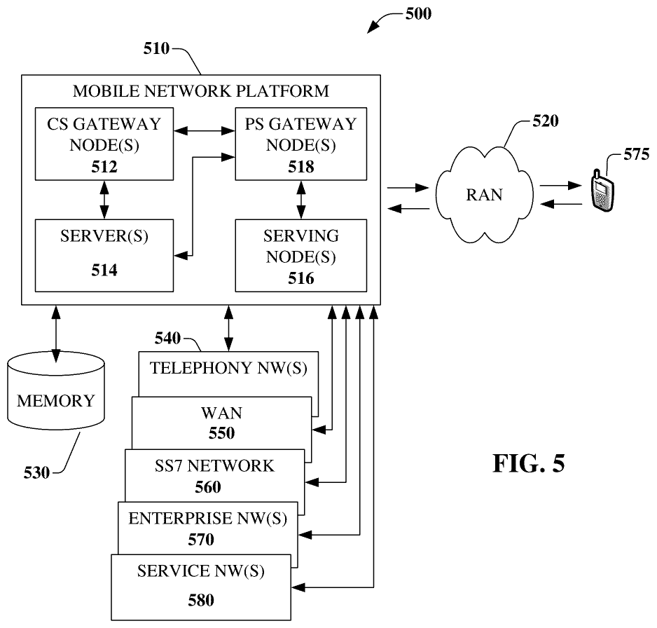

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part receiving, over a network, a captured reaction of a user experiencing a stimulus, where the stimulus is presented during accessing of an application by the user at an end user device; analyzing the captured reaction by a comparison with a baseline reaction of the user that is previously obtained; and providing an authentication over the network to the end user device in response to the comparison.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1 (s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

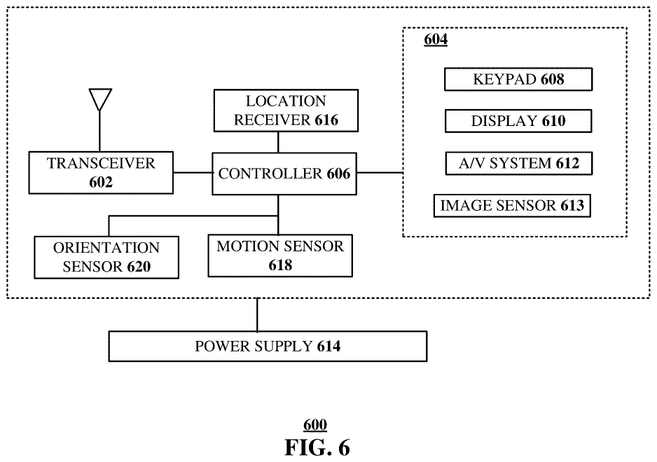

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part receiving, over a network, a captured reaction of a user experiencing a stimulus, where the stimulus is presented during accessing of an application by the user at an end user device; analyzing the captured reaction by a comparison with a baseline reaction of the user that is previously obtained; and providing an authentication over the network to the end user device in response to the comparison.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and cast, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . . xₙ), to a confidence that the input belongs to a class, that is, f (x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method comprising:
receiving, by a processing system including a processor over a network, an authentication request associated with a user accessing an application of an end user device;
providing, by the processing system over the network, stimulus information, wherein the providing of the stimulus information causes a stimulus to be presented to the user independent of user interaction with the end user device, wherein the stimulus is presented during the accessing of the application by the user;
receiving, by the processing system over the network, a captured reaction of the user experiencing the stimulus;
analyzing, by the processing system, the captured reaction by a comparison with a baseline reaction of the user; and
providing, by the processing system, an authentication in response to the comparison satisfying a reaction threshold.

2. The method of claim 1, comprising:
obtaining, by the processing system, baseline information including the baseline reaction prior to the receiving of the authentication request.

3. The method of claim 1, wherein the application includes video streaming, and wherein the stimulus includes an object inserted into video of the video streaming.

4. The method of claim 3, wherein the captured reaction includes one or more images of the user captured during a presentation of the stimulus.

5. The method of claim 4, wherein the captured reaction is captured by a sensor of the end user device.

6. The method of claim 3, comprising:
determining a position for the object to be inserted into the video, wherein the stimulus information includes the position for the object.

7. The method of claim 6, comprising:
determining a presentation characteristic for the object that includes at least one of a size, a shape, a brightness or a color for the object that is to be inserted into the video, wherein the stimulus information includes the presentation characteristic.

8. The method of claim 7, wherein the providing of the stimulus information is to a device that is separate from the end user device, wherein the device presents the stimulus.

9. The method of claim 1, wherein the receiving of the captured reaction is from one of the end user device or a sensor that is separate from the end user device.

10. The method of claim 1, comprising:
determining, by the processing system, a location of the user; and
providing, by the processing system, a request to a sensor according to the location to record the user experiencing the stimulus resulting in the captured reaction.

11. The method of claim 10, wherein the sensor includes a camera at the location of the user.

12. The method of claim 10, wherein the application includes video streaming, and wherein the captured reaction includes a gaze location of the user with respect to a display on which video and the stimulus is presented.

13. The method of claim 1, wherein the analyzing the captured reaction includes applying an Artificial Intelligence (AI) model to the captured reaction.

14. A device, comprising:
a processing system including a processor; and
a memory that stores executable instructions that, when executed by the processing system, facilitate performance of operations, the operations comprising:
receiving, over a network, a captured reaction of a user experiencing a stimulus, wherein the stimulus is presented during accessing of an application by the user at an end user device;
analyzing the captured reaction by a comparison with a baseline reaction of the user that is previously obtained; and
providing an authentication over the network to the end user device in response to the comparison.

15. The device of claim 14, wherein the captured reaction includes a gaze location of the user with respect to a display on which the application is presenting a video and the stimulus is presented in the video.

16. The device of claim 15, wherein the stimulus is an object that is selected in the video based on a determination to be of interest to the user, and wherein the gaze location satisfies a gaze location threshold.

17. The device of claim 16, wherein the operations further comprise:
selecting the object from among a group of objects appearing in the video, wherein the selecting is based on a determination of interest to the user;
identifying a time period in which the object is to be presented in the video; and
providing instructions for capturing images of the user during the time period resulting in the captured reaction.

18. The device of claim 17, wherein the operations comprise:
determining a location of the user; and
providing the instructions to a sensor according to the location to capture the images.

19. The device of claim 18, wherein the sensor is a separate device from the end user device.

20. A non-transitory machine-readable medium, comprising executable instructions that, when executed by a processing system including a processor of an end user device, facilitate performance of operations, the operations comprising:
providing a user with access to an application being executed via the end user device;
providing, over a network, an authentication request associated with the access by the user; and
receiving, over the network, an authentication in response to a comparison satisfying a reaction threshold, wherein the comparison is performed by a processing system, wherein the comparison is of a captured reaction of the user experiencing a stimulus with a baseline reaction of the user, wherein the stimulus is presented to the user independent of user interaction with the end user device, and wherein the stimulus is presented during accessing of the application by the user.
